(19) United States
(12) Patent Application Publication
(10) Pub. No.: US 2010/0229083 A1
(43) Pub. Date: Sep. 9, 2010

(54) SCREEN DISPLAY PROGRAM GENERATING APPARATUS, SCREEN DISPLAY SYSTEM, COMPUTER READABLE STORAGE MEDIUM HAVING STORED THEREIN A COMPUTER PROGRAM CAUSING A COMPUTER TO FUNCTION AS THE SCREEN DISPLAY PROGRAM GENERATING APPARATUS, AND SCREEN DISPLAY PROGRAM GENERATING METHOD

(75) Inventors: Yumiko Mouri, Tokyo (JP); Ryota Tsukamoto, Tokyo (JP); Akihiro Baba, Tokyo (JP); Mitsuyoshi Yamatari, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC, Chiyoda-ku (JP)

(21) Appl. No.: 12/538,474

(22) Filed: Aug. 10, 2009

(30) Foreign Application Priority Data
Mar. 6, 2009 (JP) 2009-053743

(51) Int. Cl. G06F 17/00

(52) U.S. Cl. 715/234; 715/243

(57) ABSTRACT

To automatically generate a screen display program where parameters vary like web service calling. A style sheet generating section 121 (a layout generating section) may generate style sheet data (a layout program) based on layout information data stored by the layout information storing section 112. A script generating section 122 (a component display generating section) may generate script data (a component display program) based on event information data stored by the event information storing section 113. An HTML generating section 125 (a screen display program generating section) may combine the style sheet data and the script data to generate HTML data (a screen display program).

### BACKGROUND OF THE INVENTION

1. Field of the Invention

The present invention relates to a screen display program generating apparatus for generating a screen display program that causes a computer to display a display screen image by using a web service or the like.

2. Description of the Related Art

Service-Oriented Architecture (SOA) is a technique known to build a new web system by utilizing existing resources, for example. With SOA, a web system is built by dividing the function of an existing system into web services, and then restructuring a divided web service. A web service can be called from a program, and data is returned as a response to a request. An example of the related art is disclosed in JP 2002-229973 A.

Source codes such as HTML source codes or script source codes always need to be prepared for displaying screen images in order to cause a computer to display a response from a web service on a web screen displayed by a browser device. Source codes, however, cannot easily be generated automatically if parameters vary within a source code as in the case of web service calling. In such cases, a source code needs to be written manually.

### SUMMARY OF THE INVENTION

The present invention is directed to solving problems such as that described above, for example. It is an object therefore to generate a source code automatically for displaying a screen image even if the screen image includes varying parameters.

These and other objects of the embodiments of the present invention are accomplished by the present invention as hereinafter described in further detail.

According to one aspect of the present invention, a screen display program generating apparatus may generate a screen display program that causes a screen display apparatus to display a display screen image including a screen component provided by a screen component providing apparatus. The screen display program generating apparatus may include a memory for storing data, a processor for processing data, a layout information storing section, an event information storing section, layout generating section, component display generating section, and a screen display program generating section. The layout information storing section may store, by using the memory, layout information data indicating a display position at which the screen component is displayed in the display screen image. The event information storing section may store, by using the memory, event information data indicating a display condition under which the screen component is displayed at the display position. The layout generating section may generate, by using the processor, a layout program based on the layout information data stored by the layout information storing section, the layout program causing the screen display apparatus to display at the display position a display area for displaying the screen component. The component display generating section may generate, by using the processor, a component display program based on the event information data stored by the event information storing section. The component display program may cause the screen display apparatus to determine whether the display condition is satisfied, request the screen component providing apparatus to provide the screen component to be displayed in the display area when it is determined that the display condition is satisfied, and display the screen component provided by the screen component providing apparatus in the display area. The screen display program generating section may combine, by using the processor, the layout program generated by the layout generating section and the component display program generated by the component display generating section for generating the screen display program. According to another aspect of the present invention, a screen display system may include the screen display program generating apparatus, and a screen design apparatus. The screen design apparatus may generate the layout information data and the event information data, based on a user's operation. The layout information storing section may store, by using the memory, the layout information data generated by the screen design apparatus. The event information storing section may store, by using the memory, the event information data generated by the screen design apparatus.

According to another aspect of the present invention, a computer readable storage medium may have stored therein a computer program for causing a computer to function as the screen display program generating apparatus.

According to another aspect of the present invention, a screen display program generating method may generate a screen display program by a screen display program generating apparatus including a processor for processing data. The screen display program may cause a screen display apparatus to display a display screen image including a screen component provided by a screen component providing apparatus. The screen display program generating method may include: generating a layout program, by the processor, based on layout information data indicating a display position at which the screen component is displayed in the display screen image; generating a component display program, by the processor, based on event information data indicating a display condition under which the screen component is displayed at the display position; and combining, by the processor, generated layout program and generated component display program to generate the screen display program. The layout program may cause the screen display apparatus to display at the display position a display area for displaying the screen component. The component display program may cause the screen display apparatus to determine whether the display condition is satisfied, request the screen component providing apparatus to provide the screen component to be displayed in the display area if it is determined that the display condition is satisfied, and display the screen component provided by the screen component providing apparatus in the display area.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an example of the overall system configuration of a screen display system 800 according to a first embodiment;

FIG. 2 illustrates an example of a display screen image 400 displayed by a browser apparatus 200 according to the first embodiment;

FIG. 3 shows an example of a perspective view illustrating an external view of a web server apparatus 100 according to the first embodiment;

FIG. 4 shows examples of hardware resources of the web server apparatus 100 according to the first embodiment;

FIG. 5 shows a functional block diagram illustrating an example configuration of the web server apparatus 100 according to the first embodiment;

FIG. 6 shows a functional block diagram illustrating an example configuration of the browser apparatus 200 according to the first embodiment;

FIG. 7 shows an example of configuration information data 510 according to the first embodiment;

FIG. 8 shows an example of layout information data 520 according to the first embodiment;

FIG. 9 shows an example of event information data 530 according to the first embodiment;

FIG. 10 shows examples of style sheet template data 560 and style sheet data 570 according to the first embodiment;

FIG. 11 shows a flow chart illustrating an example flow of a style sheet generating process S710 according to the first embodiment;

FIG. 12 shows examples of script template data 580 and script data 590 according to the first embodiment;

FIG. 13 shows a flow chart illustrating an example flow of a script generating process S730 according to the first embodiment;

FIG. 14 shows examples of body template data 610 and body data 620 according to the first embodiment;

FIG. 15 shows a flow chart illustrating an example flow of a body generating process S750 according to the first embodiment;

FIG. 16 shows examples of HTML template data 630 and HTML data 640 according to the first embodiment;

FIG. 17 shows a flow chart illustrating an example flow of an HTML generating process S760 according to the first embodiment;

FIG. 18 shows examples of screen component data 650 and screen configuration data 660 according to the first embodiment;

FIG. 19 shows a flow chart illustrating an example flow of a screen component generating/displaying process according to the first embodiment;

FIG. 20 shows an example of the overall system configuration of a screen display system 800 according to a second embodiment; and

FIG. 21 shows a functional block diagram illustrating an example configuration of a screen design apparatus 300 according to the second embodiment.

### DETAILED DESCRIPTION OF THE PREFERRED EMBODIMENTS

Reference will now be made in detail to the present preferred embodiments of the invention, examples of which are illustrated in the accompanying drawings, wherein like reference numerals indicate like devices through out the several views.

### Embodiment 1

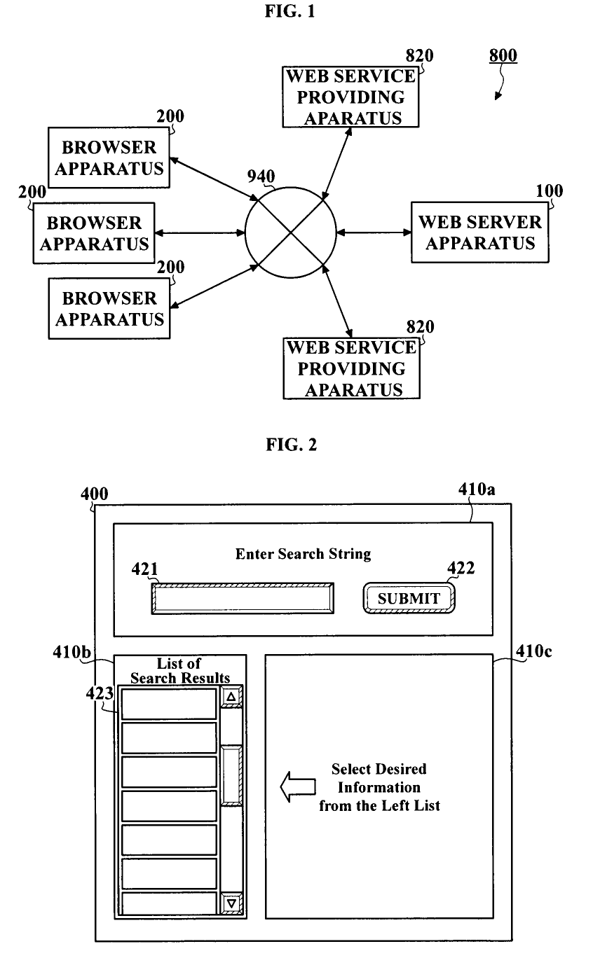

A first embodiment is now described with reference to FIG. 1 to FIG. 19.

FIG. 1 shows an example of the overall system configuration of a screen display system 800 according to this embodiment.

The screen display system 800 is a system that allows a screen image (hereinafter, referred to as a “display screen image”) such as a web page to be displayed on the screen of a browser apparatus 200. Display screen images displayed on the screen of the browser apparatus 200 may include a dynamic screen image that varies dynamically in response to a user's operation, in addition to a static screen image.

The browser apparatus 200 may be a computer that functions as the browser apparatus 200 by executing a browser application program, for example.

The browser apparatus 200 may request a web server apparatus 100, via a network such as the Internet, to provide a desired display screen image, based on a user's operation or the like.

The web server apparatus 100 may transmit a program (hereinafter, referred to as a “screen display program”) in an HTML format or the like to the browser apparatus 200, upon request from the browser apparatus 200. The screen display program may represent not only the configuration of a display screen image to be displayed at beginning, but also the detail of a process for varying the screen image in response to a user's operation. With an HTML format, a script part may represent the detail of a process and the other parts may represent the configuration of the display screen image, for example. The browser apparatus 200 may receive a screen display program, and execute the received screen display program to generate a display screen image and display the generated display screen image.

A web service providing apparatus 820 may provide web services. There are existing services available only via web pages, such as a service for retrieving a web page based on a keyword or a service for displaying a map based on an address. A web service may be defined as a service that allows the existing service to be provided without involving web pages, by making the Application Program Interface (API) of the service available to the public.

The display screen image displayed by the browser apparatus 200 may include a portion made up based on information acquired from a web service provided by the web service providing apparatus 820. The browser apparatus 200 may change a web service to be called, a parameter to be given to a web service, or the like according to a screen display program in execution based on a user's operation or the like, thereby generating a dynamic screen image.

It should be noted that the web service providing apparatus 820 needs not necessarily be connected to the Internet 940. The web service providing apparatus 820 may alternatively be connected to the web server apparatus 100 via a Local Are Network (LAN) or the like.

FIG. 2 illustrates an example of a display screen image 400 displayed by a browser apparatus 200 according to this embodiment.

The display screen image 400 is made up by a plurality of screen components 410a to 410c.

The screen component 410a is provided for inputting a string. The screen component 410a includes a text box 421 and a submit button 422.

The screen component 410b is provided for displaying a list of search results. The screen component 410b includes list boxes 423. When a user enters a string in the text box 421 and clicks the submit button 422, then a search for the string is conducted by using a retrieval service provided by the web service providing apparatus 820, and a search result is then displayed in the list box 423.

The screen component 410c is provided for displaying the detail of a search result. When a user selects an item from among search results displayed in the list boxes 423, then detailed information relating to the selected item is retrieved by using a dictionary service, a map service, or the like provided by the web service providing apparatus 820, and then displayed in the screen component 410c.

The display screen image 400 may thus change dynamically in response to a user's operation or based on a result returned from the web service providing apparatus 820.

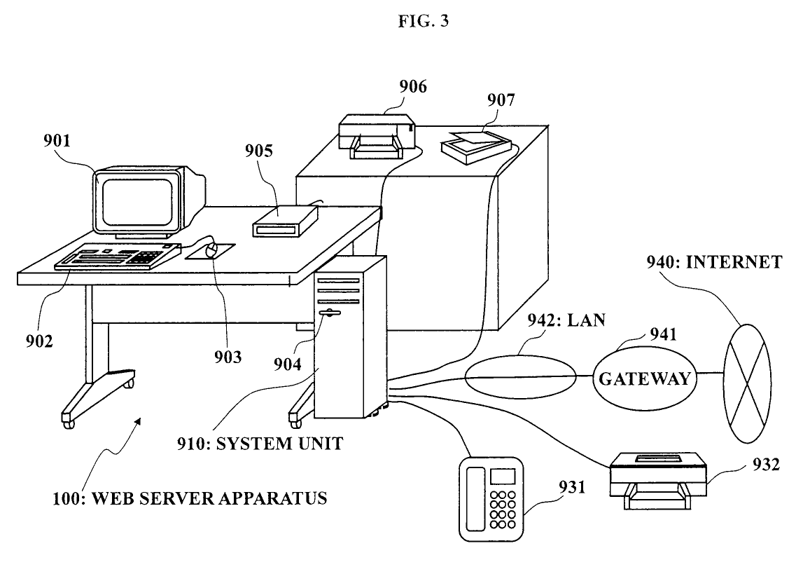

FIG. 3 shows a perspective view illustrating an external view of the web server apparatus 100 according to this embodiment. It should be noted that an external view of the browser apparatus 200 may be the same as that of the web server apparatus 100.

The web server apparatus 100 and the browser apparatus 200 may be configured to include hardware resources, such as a system unit 910, a display 901 having a CRT (Cathode Ray Tube) display screen or an LCD (Liquid Crystal Display) display screen, a keyboard (K/B) 902, a mouse 903, a Flexible Disk Drive (FDD) 904, a compact disk drive (CDD) 905, a printer 906, and a scanner 907, which are connected to one another via cables or signal lines.

The system unit 910 is a computer, connected to a facsimile machine 932 and a telephone machine 931 via cables, and also connected to the Internet 940 via a local area network 942 (LAN) and a gateway 941.

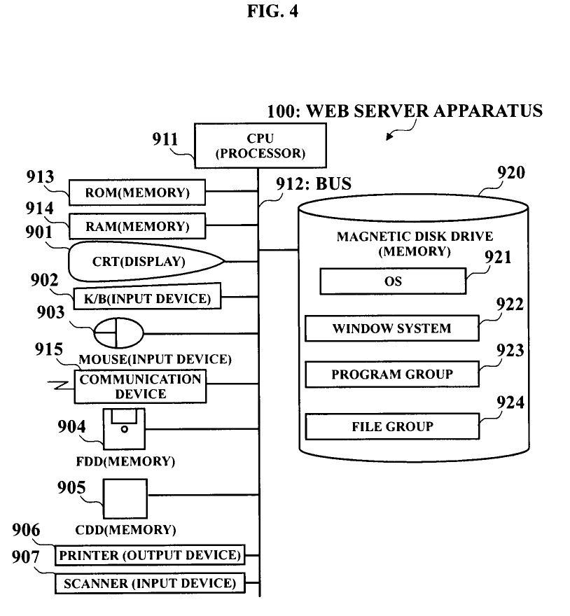

FIG. 4 shows examples of the hardware resources of the web server apparatus 100 according to this embodiment. It should be noted that the hardware resources of the browser apparatus 200 may be the same as that of the web server apparatus 100.

The web server apparatus 100 and the browser apparatus 200 may be equipped with a Central Processing Unit (CPU) 911, which may be referred to as a processor, a computer, a microprocessor, or a micro computer. The CPU 911 may be connected, via the bus 912, to a ROM 913, a RAM 914, a communication device 915, the display 901, the keyboard 902, the mouse 903, the FDD 904, the CDD 905, the printer 906, the scanner 907, and a magnetic disk drive 920, to control those hardware devices. The magnetic disk drive 920 may be replaced by a storage device such as an optical disk drive, or a memory card read/write device.

The RAM 914 is an example of a volatile memory. The ROM 913, and the storage media of the FDD 904, the CDD 905, and the magnetic disk drive 920 are examples of nonvolatile memories. The volatile memory and nonvolatile memories are examples of storage units or storing sections. The communication device 915, the keyboard 902, the scanner 907 and the FDD 904 are examples of inputting sections or input devices. The communication device 915, the display 901, the printer 906 are examples of outputting sections or output devices.

The communication device 915 may be connected to the facsimile machine 932, the telephone unit 931, the LAN 942, and the like. The communication device 915 may alternatively be connected to the Internet 940 or a Wide Area Network (WAN) such as IDSN or the like. If the communication device 915 is connected to the Internet 940 or a WAN such as ISDN, then the gateway 941 is made redundant.

The magnetic disk drive 920 may store an operating system (OS) 921, a window system 922, a program group 923, and a file group 924. The programs of the program group 923 may be executed by the CPU 911, the operating system 921 and the window system 922.

The program group 923 may store a program for executing a function referred to as a “section” in the following descriptions of this and other embodiments. The programs may be read and executed by the CPU 911.

The file group 924 may store information, data, a signal value, a variable value, and a parameter, which are referred to as a “determination result”, a “calculation result”, or a “process result” in the following descriptions of this and other embodiments, as a “file” item and a “database” item. A “file” and a “database” may be stored in a storage medium such as a disk or a memory. Information, data, signal values, variable values, and parameters stored in a storage medium, such as a disk or a memory, may be read by the CPU 911 to be buffered in a main memory or a cache memory, via a read/write circuit, for a CPU operation for extraction, retrieval, reference, comparison, arithmetic operation, calculation, processing, outputting, displaying, or the like. Information, data, signal values, variable values, parameters may be buffered temporarily in a main memory, a cache memory, or a buffer memory during the CPU operation for extraction, retrieval, reference, comparison, arithmetic operation, calculation, processing, outputting, displaying, or the like.

Arrows shown in the flow charts of the accompanying drawings for describing this and other embodiments primarily indicate the input/output of data or signals. Data and signal values may be stored in the RAM 914 for a memory, the FDD 904 for a flexible disk, the CDD 905 for a compact disk, the magnetic disk drive 920 for a magnetic disk, or any other type of storage medium such as an optical disk, a minidisk, and a Digital Versatile Disk (DVD). The data and signals may be transmitted online by way of the bus 912, a signal line, a cable, or any other type of transmission medium.

It should be noted that an element described as a “section” in the following descriptions of this and other embodiments may be replaced by a “circuit”, a “device”, or “equipment”, or even by a “step”, a “procedure”, or a “process”. More specifically, the element described as a “section” may be implemented by firmware stored in the ROM 913. Alternatively, the element described as a “section” may be implemented by exclusively by software; exclusively by hardware such as an elemental device, a device, a substrate, or wiring; by a combination of software and hardware; or by a combination of software, hardware and firmware. Firmware and software may be stored each as a program, in a storage medium, such as a magnetic disk, a flexible disk, an optical disk, a compact disk, a mini disk, a DVD, or the like. The program is read and executed by the CPU 911. More specifically, the program causes a computer to function as a “section” described below, or causes a computer to execute the procedure of a method by a “section” described below.

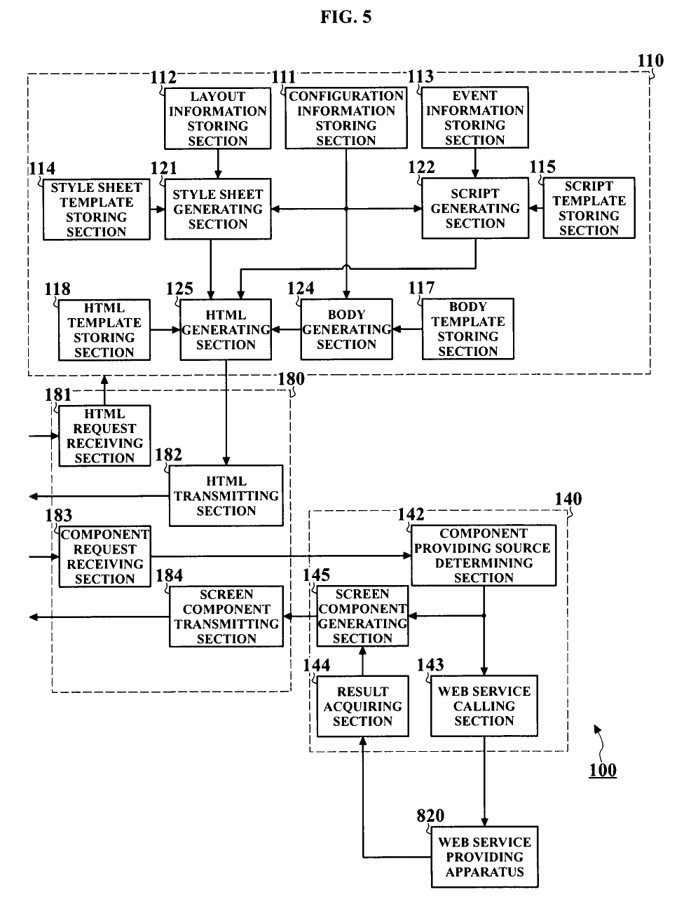

FIG. 5 shows a functional block diagram illustrating an example configuration of the web server apparatus 100 according to this embodiment.

The web server apparatus 100 may be configured to include a code generating section 110, a request transferring section 140 and a transmitting/receiving section 180.

The code generating section 110 may generate data (hereinafter, referred to as “HTML data”) in an HTML format upon request from the browser apparatus 200. It should be noted that the code generating section 110 may generate and store HTML data in advance.

The HTML data generated by the code generating section 110 may include a script for transmitting a request for a screen component (hereinafter referred to as a “screen component request”) to the web server apparatus 100. The browser apparatus 200 may execute this script to transmit the screen component request to display the display screen image 400 or modify the display screen image 400 according to a user's operation, or the like.

The request transferring section 140 may generate data representing a screen component (hereinafter, referred to as “screen component data”) upon receipt of the screen component request from the browser apparatus 200. When a web service is to be used to generate requested screen component data, the request transferring section 140 may transfer the screen component request to the web service providing apparatus 820 that provides that specific web service, and generate the screen component data based on a result.

The transmitting/receiving section 180 may receive the request from the browser apparatus 200. If the received request is a request for the transmission of the HTML data (hereinafter, referred to as an “HTML request”), then the transmitting/receiving section 180 notifies the code generating section 110 of that request. If the received request is the screen component request, then the transmitting/receiving section 180 notifies the request transferring section 140 of this request. The transmitting/receiving section 180 may transmit the HTML data generated by the code generating section 110 or the screen component data generated by the request transferring section 140 to the browser apparatus 200.

The code generating section 110 may include a configuration information storing section 111, a layout information storing section 112, an event information storing section 113, a style sheet template storing section 114, a script template storing section 115, a body template storing section 117, an HTML template storing section 118, a style sheet generating section 121, a script generating section 122, a body generating section 124, and an HTML generating section 125.

The configuration information storing section 111 may store configuration information data in advance by using a magnetic disk drive 920. The configuration information data may be defined as data that indicates an overall configuration of the display screen image 400, such as the screen component making up the display screen image 400.

The layout information storing section 112 may store layout information data in advance by using the magnetic disk drive 920. The layout information data may be defined as data that indicates the physical appearance of the display screen image 400, such as the display position of a screen component.

The event information storing section 113 may store event information data in advance by using the magnetic disk drive 920. The event information data may be defined as data that indicates an action in the display screen image 400, such as a relation between an event such as a user's operation and a corresponding process to be performed upon occurrence of that specific event, or the like.

The style sheet template storing section 114 may store a template (hereinafter referred to as “style sheet template data”) for generating a style sheet based on the layout information data, in advance by using the magnetic disk drive 920. The style sheet may be defined as data that defines a part of the HTML data relating to the physical appearance of the display screen image 400, such as the display position, the size or the color of an element.

The style sheet generating section 121 may input the configuration information data stored by the configuration information storing section 111, the layout information data store by the layout information storing section 112, and the style sheet template data stored by the style sheet template storing section 114, by using the CPU 911. The style sheet generating section 121 may generate style sheet data, by using the CPU 911, based on the inputted configuration information data, the inputted layout information data, and the inputted style sheet template data. The style sheet data may be defined as data that makes up a style sheet as part of the HTML data. More specifically, the style sheet generating section 121 extracts data to be embedded in a blank space provided in the style sheet template data from the configuration information data or the layout information data, and then fills the blank space in the style sheet template data with the extracted data, by using the CPU 911, thereby thus generating the style sheet data, for example. The style sheet generating section 121 may then output the generated style sheet data, by using the CPU 911.

The script template storing section 115 may store a template (hereinafter, referred to as “script template data”) for generating a script based on the event information data, in advance by using the magnetic disk drive 920. The script may be defined as data that defines a part of the HTML data relating to a process or an action. The script may be written in a script language, for example.

The script generating section 122 may input the configuration information data stored by the configuration information storing section 111, the event information data stored by the event information storing section 113, and the script template data stored by the script template storing section 115, by using the CPU 911. The script generating section 122 may then generate script data, by using the CPU 911, based on the inputted configuration information data, the inputted event information data and the inputted script template data. The script data may be defined as data that makes up a script as part of the HTML data. More specifically, the script generating section 122 extracts data to be embedded in a blank space provided in the script template data from the configuration information data and the event information data, and then fills the blank space in the script template data with the extracted data, by using the CPU 911, thereby thus generating the script data, for example. The script generating section 122 may then output the generated script data, by using the CPU 911.

The body template storing section 117 may store a template (hereinafter referred to as “body template data”) for generating the body of the HTML data based on the configuration information data, in advance by using the magnetic disk drive 920. The body of the HTML data may be defined as data that defines a part of the HTML data relating to the configuration of an initial screen.

The body generating section 124 may input the configuration information data stored by the configuration information storing section 111 and the body template data stored by the body template storing section 117, by using the CPU 911. The body generating section 124 may then generate body data, by using the CPU 911, based on the inputted configuration information data and the inputted body template data. The body data may be defined as data that makes up a body as part of the HTML data. More specifically, the body generating section 124 extracts data to be embedded in a blank space provided in the body template data from the configuration information data, and then fills the blank space in the body template data with the extracted data, by using the CPU 911, thereby thus generating the body data, for example. The body generating section 124 may then output the generated body data, by using the CPU 911.

The HTML template storing section 118 may store a template (hereinafter referred to as “HTML template data”) for generating the HTML data based on the style sheet data, the script data, and the body data, in advance by using the magnetic disk drive 920.

The HTML generating section 125 may input the style sheet data outputted by the style sheet generating section 121, the script data outputted by the script generating section 122, the body data outputted by the body generating section 124, and the HTML template data stored by the HTML template storing section 118, by using the CPU 911. The HTML generating section 125 may then generate the HTML data, by using the CPU 911, based on the inputted style sheet data, the inputted script data, the inputted body data, and the inputted HTML template data. More specifically, the HTML generating section 125 embeds the style sheet data, the script data and the body data in blank spaces provided in the HTML template data, by using the CPU 911, thereby thus generating the HTML data, for example. The HTML generating section 125 may then output the generated HTML data, by using the CPU 911.

The transmitting/receiving section 180 may include an HTML request receiving section 181, an HTML transmitting section 182, a component request receiving section 183, and a screen component transmitting section 184.

The HTML request receiving section 181 may receive the HTML request transmitted to the web server apparatus 100 by the browser apparatus 200, by using a communication device 915. The HTML request receiving section 181 may notify the code generating section 110 of the received HTML request, by using the CPU 911. The code generating section 110 may output the generated HTML data upon receipt of a notification of the HTML request, by using the CPU 911.

The HTML transmitting section 182 may input the HTML data outputted by the code generating section 110, by using the CPU 911. The HTML transmitting section 182 may then transmit the inputted HTML data to the browser apparatus 200, by using the communication device 915.

The component request receiving section 183 may receive the screen component request transmitted to the web server apparatus 100 by the browser apparatus 200, by using the communication device 915. The component request receiving section 183 may then notify the request transferring section 140 of the received screen component request, by using the CPU 911. The request transferring section 140 may then output the generated screen component data upon notification of the screen component request, by using the CPU 911.

The screen component transmitting section 184 may input the screen component data outputted by the request transferring section 140, by using the CPU 911. The screen component transmitting section 184 may then transmit the inputted screen component data to the browser apparatus 200, by using the communication device 915.

The request transferring section 140 may include a component providing source determining section 142, a web service calling section 143, a result acquiring section 144, and a screen component generating section 145.

The component providing source determining section 142 may input the screen component request notified by the transmitting/receiving section 180, by using the CPU 911. The component providing source determining section 142 may then determine whether the requested screen component uses a web service or not, by using the CPU 911, based on the received screen component request. If it is determined that the screen component uses a web service, then the component providing source determining section 142 may further determine which web service providing apparatus 820 provides that specific web service. The component providing source determining section 142 may then output a determination result, by using the CPU 911.

The web service calling section 143 may input the determination result outputted by the component providing source determining section 142, by using the CPU 911. The web service calling section 143 may then transfer the screen component request to the web service providing apparatus 820 providing that specific web service to be used, by using the communication device 915, based on the inputted determination result.

The result acquiring section 144 may receive a result of the web service transmitted to the web server apparatus 100 by the web service providing apparatus 820, by using the communication device 915. The result acquiring section 144 may then output the received result, by using the CPU 911. It should be noted that the result of the web service transmitted by the web service providing apparatus 820 may be available as the screen component data without any modification or may be data written in an XML (Extensible Markup Language) format, for example.

The screen component generating section 145 may input the result outputted by the result acquiring section 144, by using the CPU 911. The screen component generating section 145 may then generate the screen component data based on the inputted result, by using the CPU 911. The screen component generating section 145 may then output generated screen component data, by using the CPU 911. If the inputted result is available as the screen component data, then the screen component generating section 145 may alternatively output the inputted result without modification as the screen component data.

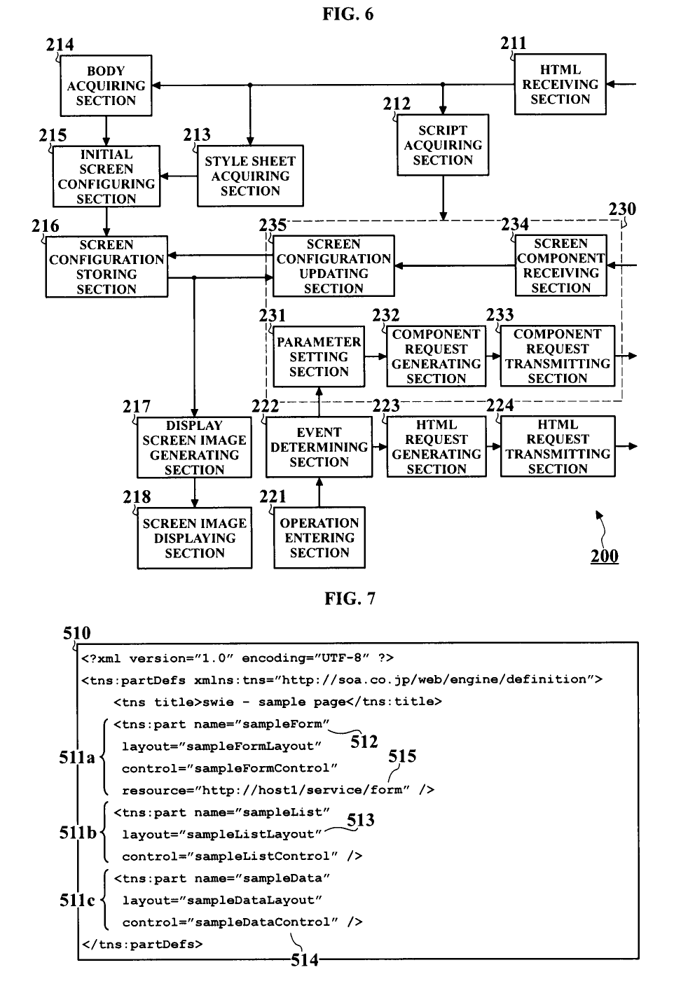

FIG. 6 shows a functional block diagram illustrating an example configuration of the browser apparatus 200 according to this embodiment.

The browser apparatus 200 may include an HTML receiving section 211, a script acquiring section 212, a style sheet acquiring section 213, a body acquiring section 214, an initial screen configuring section 215, a screen configuration storing section 216, a display screen image generating section 217, a screen image displaying section 218, an operation inputting section 221, an event determining section 222, an HTML request generating section 223, an HTML request transmitting section 224, and a script executing section 230.

The HTML receiving section 211 may receive the HTML data transmitted by the web server apparatus 100, by using the communication device 915.

The script acquiring section 212 may extract the script data from the HTML data received by the HTML receiving section 211, by using the CPU 911.

The style sheet acquiring section 213 may extract the style sheet data from the HTML data received by the HTML receiving section 211, by using the CPU 911.

The body acquiring section 214 may extract the body data from the HTML data received by the HTML receiving section 211, by using the CPU 911.

The initial screen configuring section 215 may generate data (hereinafter, referred to as “screen configuration data”) representing the configuration of a display screen image at beginning, by using the CPI 911, based on the style sheet data extracted by the style sheet acquiring section 213 and the body data extracted by the body acquiring section 214.

The screen configuration storing section 216 may store the screen configuration data generated by the initial screen configuring section 215, by using the RAM 914.

The display screen image generating section 217 may generate a display screen image based on the screen configuration data stored by the screen configuration storing section 216, by using the CPU 911.

The screen image displaying section 218 may display the display screen image generated by the display screen image generating section 217, by using the display 901.

The operation inputting section 221 may input a user's operation by using an input device (hereinafter, referred to as an “operation inputting device”) such as the keyboard 902 and the mouse 903.

The event determining section 222 may determine whether an event has occurred or not, by using the CPU 911, based on the operation inputted by the operation inputting section 221 or the like.

The HTML request generating section 223 may determine whether the HTML request is to be issued or not, by using the CPU 911, based on the event determined by the event determining section 222, or the like. If it is determined that the HTML request is to be issued, then the HTML request generating section 223 may generate the HTML request, by using the CPU 911. It is determined that the HTML request is to be issued when a user clicks a link displayed on the display screen, for example.

The HTML request transmitting section 224 may transmit the HTML request generated by the HTML request generating section 223 to the web server apparatus 100, by using the communication device 915.

The script executing section 230 may execute the script data extracted by the script acquiring section 212. The script executing section 230 may function as a parameter setting section 231, a component request generating section 232, a component request transmitting section 233, a screen component receiving section 234, and a screen configuration updating section 235, by executing the script data generated by the web server apparatus 100 of this embodiment.

The parameter setting section 231 may input the determination result obtained by the event determining section 222, by using the CPU 911. The parameter setting section 231 may then set a parameter of the screen component request, by using the CPU 911, if the inputted determination result indicates that a predetermined event has occurred. The parameter is a variable value changing in each case, such as a search string or a selected item, for example. The parameter setting section 231 may then output the set parameter, by using the CPU 911.

The component request generating section 232 may input the parameter outputted by the parameter setting section 231, by using the CPU 911. The component request generating section 232 may then generate the screen component request based on the inputted parameter, by using the CPU 911.

The component request transmitting section 233 may input the screen component request generated by the component request generating section 232, by using the CPU 911. The component request transmitting section 233 may then transmit the inputted screen component request to the web server apparatus 100, by using the communication device 915.

The screen component receiving section 234 may receive the screen component data transmitted to the browser apparatus 200 by the web server apparatus 100, by using the communication device 915. The screen component receiving section 234 may then output the inputted screen component data, by using the CPU 911.

The screen configuration updating section 235 may input the screen component data outputted by the screen component receiving section 234, by using the CPU 911. The screen configuration updating section 235 may then update the screen configuration data stored by the screen configuration storing section 216, by using the CPU 911, based on the inputted screen component data. More specifically, the screen configuration updating section 235 embeds a screen component in a display screen image, by connecting the screen component data to the screen configuration data at a specified position, by using the CPU 911, for example. The screen configuration storing section 216 may then store the screen configuration data updated by the screen configuration updating section 235, by using the RAM 914. The display screen image generating section 217 may generate a new display screen image, and the screen image displaying section 218 may display the new display screen image.

The browser apparatus 200 may thus display the display screen image involving the change by a web service used in response to a user's operation.

A description is now given of the various types of data described above in detail. It should be noted that the configuration information data, the layout information data, and the event information data may not only be written in an XML format employed in the following description, as an example, but also be written in other types of data formats, such as a CSV format, a table format, and a database format. This is also true with the other types of data described herein, which may thus be written in a different type of data format other than that used in the following description as an example.

A description is now given with reference to an example of data for generating the display screen image 400 shown in FIG. 2.

FIG. 7 shows an example of configuration information data 510 according to this embodiment.

In the accompanying drawings, in the case that there are plural elements or the like assigned the same reference numerals, a letter, such as “a,” “b,” or “c,” may be appended after the reference numerals in order to distinguish them.

The configuration information data 510 may include at least one item of screen component definition data 511. The screen component definition data 511 may be defined as data that defines the screen component for making up the display screen image 400. With this specific example, the configuration information data 510 includes three items of screen component definition data 511a to 511c corresponding to three screen components 410a to 410c that make up the display screen image 400 shown in FIG. 2.

It should be noted that the screen component to be displayed is generated by the request transferring section 140 in response to the screen component request. The screen component definition data 511 does not define the specific detail of the screen component. The screen component definition data 511 may link to a specific screen component the layout information data defining a specific display area for displaying that specific screen component and the event information data defining a process in response to an event occurred in that specific display area.

The screen component definition data 511 may include a name 512, a layout 513, a control 514, and a resource 515, for example.

The name 512 may indicate an identification name (ID) to be used to refer to a specific screen component.

The layout 513 may indicate the name of a part of the layout information data (hereinafter, referred to as “layout definition data”) that defines the display area or the like of that specific screen component.

The control 514 may indicate the name of a part of the event information data (hereinafter, referred to as “control definition data”) that defines a process or the like relating to an event occurred in the display area of that specific screen component.

The resource 515 may indicate the providing source that provides the screen component to be displayed at beginning. The screen component definition data 511 needs not necessarily include the resource 515, in which case nothing is displayed at the beginning. With this specific example, the resource 515 is specified in the screen component definition data 511a, because the screen component 410a defined by the screen component definition data 511a needs to have the text box 421 and the transmission button 422 displayed at the beginning. However, the resource 515 is not specified in the screen component definition data 511b and the screen component definition data 511c, because the screen component 410b and the screen component 410c defined respectively by the screen component definition data 511b and the screen component definition data 511c need not to have data displayed at the beginning. The list of search results and the details are to be displayed only after a search string is entered.

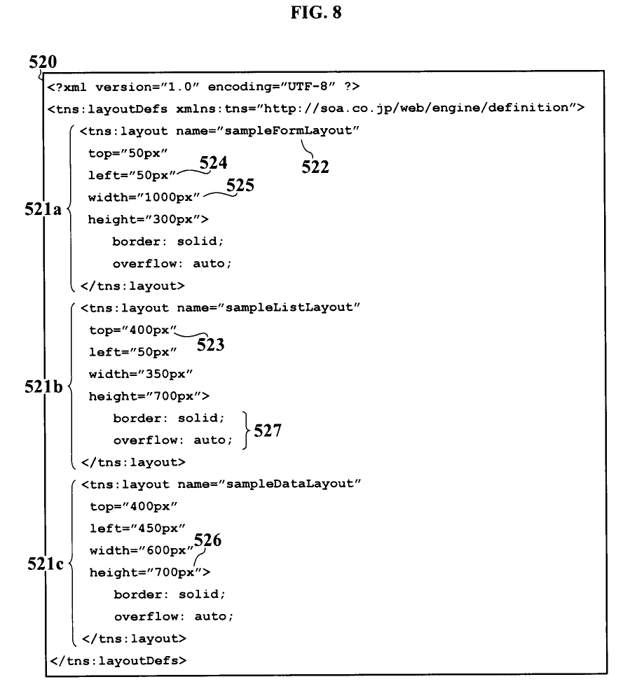

FIG. 8 shows an example of layout information data 520 according to this embodiment.

The layout information data 520 may include at least one item of layout definition data 521. The layout definition data 521 may be defined as data that defines the display position or the like of the screen component. With this specific example, the layout information data 520 includes three items of the layout definition data 521a to 521c. The number of the items of the layout definition data 521 needs not necessarily accord with the number of the screen components 410 of the display screen image 400.

The layout definition data 521 may include a name 522, a top position 523, a left position 524, a width 525, a height 526, and a style 527.

The name 522 may indicate an identification name to be used to refer to the layout definition data 521. With this specific example, the layout definition data 521 is not associated directly with the screen component, but linked via the screen component definition data 511 to the screen component, for versatility and reusability. More specifically, the layout definition data 521 having the name 522 that matches the layout 513 included in the screen component definition data 511 is linked to the screen component defined by the screen component definition data 511, for example. It should be noted that the layout definition data 521 may be directly associated with the screen component.

The top position 523 may be defined as a distance between the top side of a rectangular area for displaying the screen component (hereinafter, referred to as a “screen component area”) and the top side of the display screen image.

The left position 524 may be defined as a distance between the left side of the screen component area of the screen component and the left side of the display screen image.

The width 525 may be defined as a distance between the left side and the right side of the screen component area of the screen component.

The height 526 may be defined as a distance between the top side and the bottom side of the screen component area of the screen component.

The above four elements may specify the size and the position of the screen component area of the screen component.

The style 527 may be used for specifying the physical appearance of the screen component, in addition to the position and the size of the screen component area. More specifically, the style 527 may specify whether to mark the border of the screen component area, how to display the screen component if it is larger in size than the screen component area, and the like, for example.

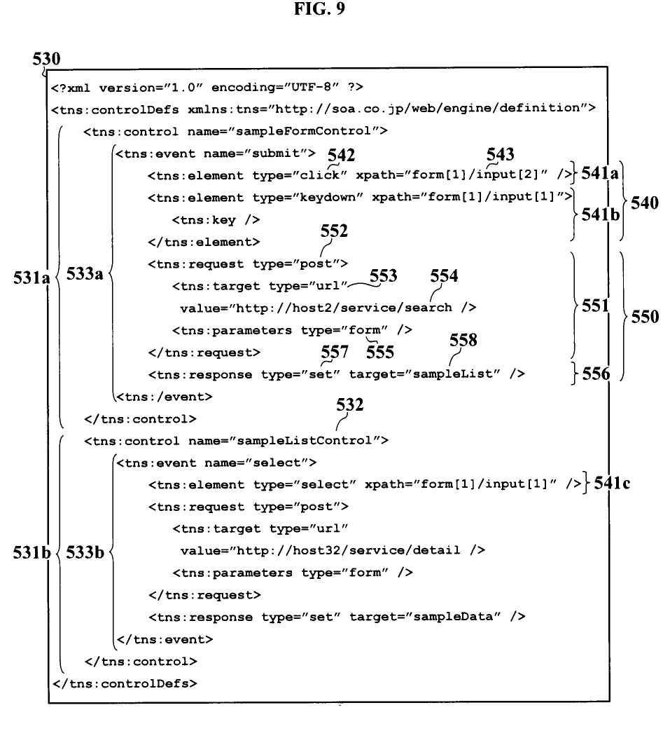

FIG. 9 shows an example of event information data 530 according to this embodiment.

The event information data 530 may include at least one item of control definition data 531. The control definition data 531 may be defined as data that defines a process or the like corresponding to an event occurred in the screen component. With this specific example, the event information data 530 includes control definition data 531a and control definition data 531b. The number of the items of the control definition data 531 needs not necessarily accord with the number of the screen components 410 of the display screen image 400.

The control definition data 531 may include a name 532 and at least one item of event definition data 533, for example.

The name 532 may indicate an identification name to be used to refer to the control definition data 531. With this specific example, the control definition data 531 is not directly associated with the screen component, but linked via the screen component definition data 511 to the screen component, in the same manner of the layout definition data 521. More specifically, the control definition data 531 having the name 532 that matches the control 514 included in the screen component definition data 511 is linked to the screen component defined by the screen component definition data 511, for example. Alternatively, the control definition data 531 may also be directly associated with the screen component, as in the case of the layout definition data 521.

The event definition data 533 may indicate correspondence between an event and a process to be performed at the occurrence of the event. With this specific example, if the same process is applied to different events occurred, one item of the event definition data 533 is used, but different items of the event definition data 533 are used if different processes are applied to different events occurred. Accordingly, the number of the items of the event definition data 533 corresponds to the number of the processes to be performed in response to events occurred in the screen component. With this specific example, the control definition data 531a includes one item of event definition data 533a. The control definition data 531b also includes one item of event definition data 533b.

The event definition data 533 may include condition specification data 540 and action specification data 550.

The condition specification data 540 may be defined as data that specifies a condition, such as the occurrence of an event, for starting an action specified by the action specification data 550. The action specification data 550 may be defined as data that specifies an action to be taken when the condition specified by the condition specification data 540 is satisfied.

The condition specification data 540 may include at least one item of condition definition data 541, for example. The condition definition data 541 may be defined as data that indicates a condition for starting an action. With this specific example, the condition specification data 540 includes condition definition data 541a and condition definition data 541b. In a situation where the condition specification data 540 includes two or more items of the condition definition data 541, an action specified by the action specification data 550 starts if a condition indicated by one of the items of the condition definition data 541 is satisfied.

The condition definition data 541 may include an event type 542 and an event target 543, for example.

The event type 542 may indicate the detail of an event, being a condition for starting an action. The event target 543 may indicate the position where the event, being a condition for starting an action, occurs.

More specifically, “form[1]/input[2]” means the second input element included in the first form included in the screen component. This indicates the submit button 422 when located in the control definition data 531a because the data 531a is linked to the screen component 410a by the screen component definition data 511a. Likewise, “form [1]/input[1]” means the first input element included in the first form included in the screen component. This indicates the text box 421 when located in the control definition data 531a because the data 531a is linked to the screen component 410a by the screen component definition data 511a. However, “form[1]/input[1]” indicates the list box 423 when located in the control definition data 531b because the data 531b is linked to the screen component 410b by the screen component definition data 511b.

The action specification data 550 may include transmission detail definition data 551 and post-reception process definition data 556, for example. The transmission detail definition data 551 may be defined as data that defines a content to be transmitted to the web server apparatus 100 as the screen component request. The post-reception process definition data 556 may be defined as data that defines how to process the screen component received from the web server apparatus 100.

The transmission detail definition data 551 may include a transmission method type 552, a request destination type 553, request destination data 554, a parameter type 555, for example.

The transmission method type 552 may indicate the type of method, such as “post” or “get”, of transferring a parameter to a request destination. The request destination may be defined as the web service providing apparatus 820 that provides a web service for generating the screen component or the like based on the screen component request.

The request destination type 553 may indicate a method of specifying the request destination. The request destination data 554 may be defined as data that specifies the request destination. If the request destination type 553 is “url”, then the request destination data 554 may indicate the URL (Uniform Resource Locator) of the request destination, for example.

The parameter type 555 may indicate where to acquire a parameter to be passed to the request destination. If the parameter type 555 is “form”, for example, it indicates that data inputted in a form including the element where the event occurred is to be passed to the request destination as a parameter to be passed to the request destination.

The post-reception process definition data 556 may include a process type 557 and a processing target component 558, for example.

The process type 557 may indicate how to process a received screen component. The processing target component 558 may indicate a screen component being a target to which a received screen component is made to operate. If the process type 557 is “set”, for example, it indicates that the screen component being the target is to be replaced by a received screen component.

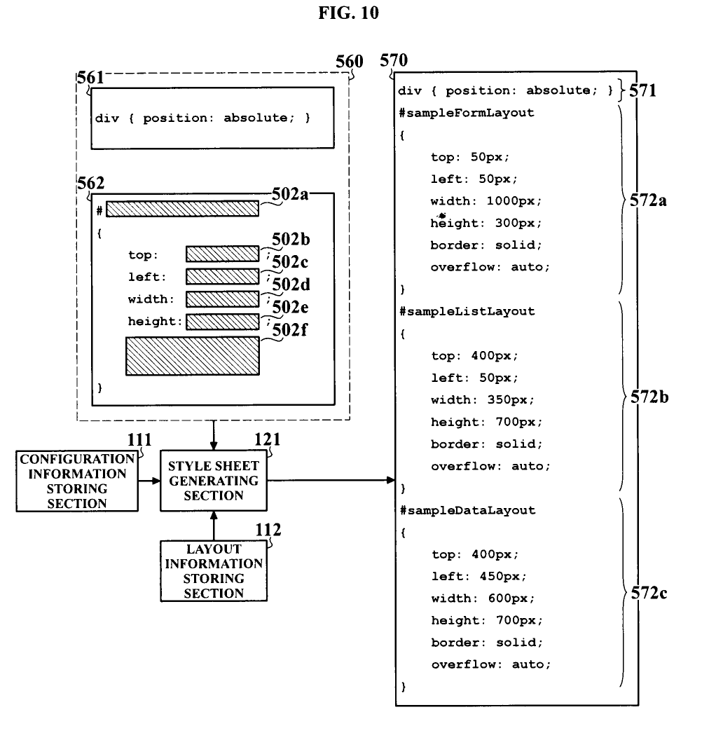

FIG. 10 shows examples of style sheet template data 560 and style sheet data 570 according to this embodiment.

The style sheet template data 560 may include whole layout template data 561 and individual layout template data 562, for example.

The whole layout template data 561 may be a template for generating a part of the layout data relating, not to individual screen components, but to the whole part of the layout data.

The individual layout template data 562 may be a template for generating a part of the layout data relating to the individual screen components. The individual layout template data 562 may include at least one blank space 502. The style sheet generating section 121 may generate the style sheet data 570 by embedding a string extracted from the configuration information data 510 or the layout information data 520 in the blank space 502. With this specific example, the individual layout template data 562 has six blank spaces 502a to 502f provided. The whole layout template data 561 of this example has no blank space provided. Alternatively, the whole layout template data 561 may have a blank space provided, as well.

With this specific example, the style sheet generating section 121 fills the blank spaces 502a to 502f of the individual layout template data 562 with data, for each screen component, by using the CPU 911, thereby generating data (hereinafter, referred to as “individual layout data”). The blank space 502a is filled with the name 512 of the screen component extracted from the screen component definition data 511 included in the configuration information data 510. The blank spaces 502b to 502f are filled with the top position 523, the left position 524, the width 525, the height 526, and the style 527, respectively, extracted from the layout definition data 521 specified by the layout 513 of the screen component definition data 511. Since the configuration information data 510 includes three items of the screen component definition data 511a to 511c, the style sheet generating section 121 generates three items of the individual layout data 572a to 572c corresponding to them. With this specific example, the whole layout template data 561 has no blank space provided. If the whole layout template data 561 has a blank space provided, then the style sheet generating section 121 may fill the blank space of the whole layout template data 561 with data, by using the CPU 911, thereby generating data (hereinafter, referred to as “whole layout data”).

The style sheet generating section 121 may combine generated whole layout data 571 (same as the whole layout template data 561 in this specific example, because the whole layout template data 561 has no blank space provided) and three items of generated individual layout data 572a to 572c, by using the CPU 911, thereby thus generating the style sheet data 570.

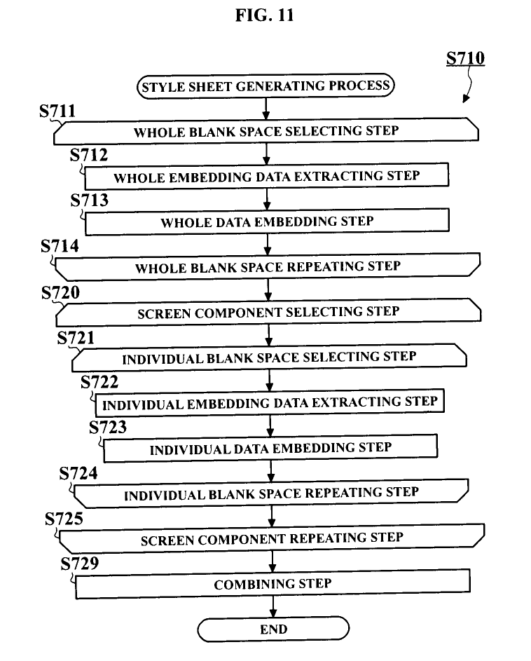

FIG. 11 shows a flow chart illustrating an example flow of a style sheet generating process S710 according to this embodiment.

In the style sheet generating process S710, the style sheet generating section 121 generates the style sheet data 570. The style sheet generating process S710 may include a whole blank space selecting step S711, a whole embedding data extracting step S712, a whole data embedding step S713, a whole blank space repeating step S714, a screen component selecting step S720, an individual blank space selecting step S721, an individual embedding data extracting step S722, an individual data embedding step S723, an individual blank space repeating step S724, a screen component repeating step S725, and a combining step S729.

In the whole blank space selecting step S711, the style sheet generating section 121 selects one at a time of blank spaces being left unfilled with data, by using the CPU 911, from among the blank spaces provided in the whole layout template data 561 stored by the style sheet template storing section 114.

In the whole embedding data extracting step S712, the style sheet generating section 121 extracts data to be embedded in the blank space selected in the whole blank space selecting step S711, by using the CPU 911, from the configuration information data 510 stored by the configuration information storing section 111 and the layout information data 520 stored by the layout information storing section 112.

In the whole data embedding step S713, the style sheet generating section 121 embeds data extracted in the whole embedding data extracting step S712 in the blank space selected in the whole blank space selecting step S711, by using the CPU 911.

In the whole blank space repeating step S714, the style sheet generating section 121 determines whether there is a blank space being left unselected in the whole blank space selecting step S711, by using the CPU 911. If it is determined that there is a blank space being left unselected, then the style sheet generating section 121 returns to the whole blank space selecting step S711 to select the next blank space, by using the CPU 911. If it is determined that every blank space has been selected, then the style sheet generating section 121 treats the whole layout template data 561 having all the blank spaces filled with data as the whole layout data 571, by using the CPU 911, and then proceeds to the screen component selecting step S720.

In the screen component selecting step S720, the style sheet generating section 121 selects one item at a time of the screen component definition data 511, by using the CPU 911, from among the configuration information data 510 stored by the configuration information storing section 111.

The style sheet generating section 121 then generates a copy of the individual layout template data 562 stored by the style sheet template storing section 114, by using the CPU 911, for the selected screen component definition data 511.

In the individual blank space selecting step S721, the style sheet generating section 121 selects one at a time of blank spaces being left unfilled with data from among the blank spaces 502a to 502f provided in the individual layout template data 562 copied in the screen component selecting step S720, by using the CPU 911.

In the individual embedding data extracting step S722, the style sheet generating section 121 extracts data to be embedded in the blank space selected in the individual space selecting step S721 from among the screen component definition data 511 selected in the screen component selecting step S720, by using the CPU 911.

In the individual data embedding step S723, the style sheet generating section 121 embeds data extracted in the individual embedding data extracting step S722 in the blank space selected in the individual blank space selecting step S721, by using the CPU 911.

In the individual blank space repeating step S724, the style sheet generating section 121 determines whether there is a blank space being left unselected in the individual blank space selecting step S721, by using the CPU 911. If it is determined that there is a blank space being left unselected, then the style sheet generating section 121 returns to the individual blank space selecting step S721, by using the CPU 911, to select the next blank space. If it is determined that every blank space has been selected, then the style sheet generating section 121 treats the individual layout template data 562 having all the blank spaces filled with data as the individual layout data 572, by using the CPU 911, and then proceeds to the screen component repeating step S725.

In the screen component repeating step S725, the style sheet generating section 121 determines whether there is an item of the screen component definition data 511 being left unselected in the screen component selecting step S720, by using the CPU 911. If it is determined that there is an item being left unselected of the screen component definition data 511, then the style sheet generating section 121 returns to the screen component selecting step S720, by using the CPU 911, to select the next item of the screen component definition data 511. If it is determined that every item of the screen component definition data 511 has been selected, then the style sheet generating section 121 proceeds to the combining step S729, by using the CPU 911.

In the combining step S729, the style sheet generating section 121 combines the whole layout data 571 and the individual layout data 572a to 572c, by using the CPU 911, thereby thus generating the style sheet data 570.

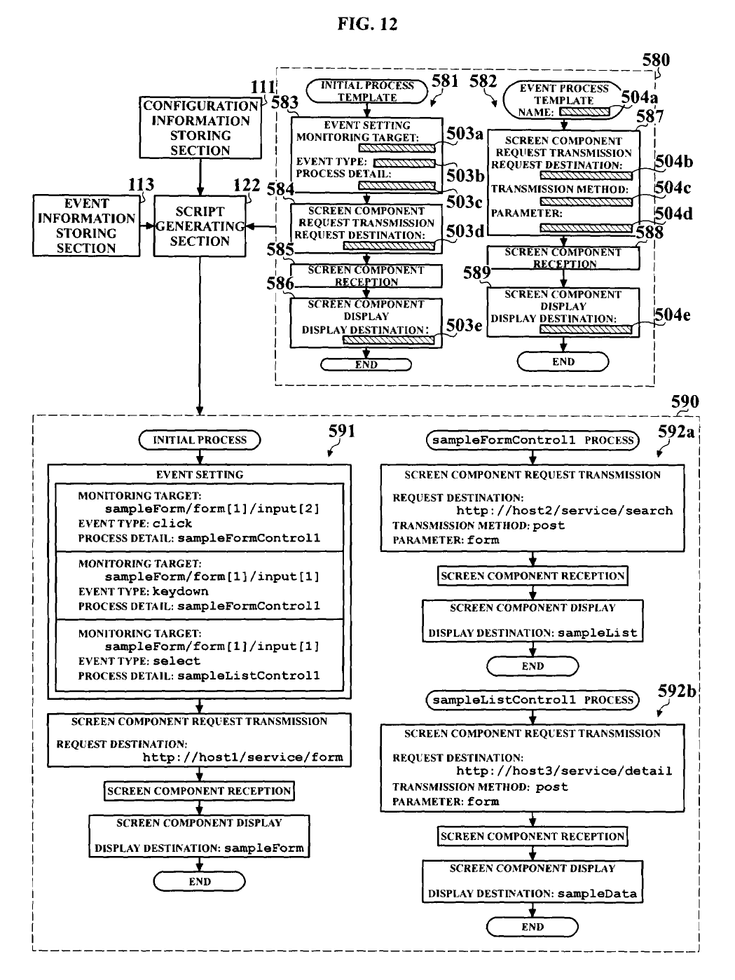

FIG. 12 shows examples of script template data 580 and script data 590 according to this embodiment.

It should be noted that the script template data 580 and the script data 590 are practically text data written in a script language, for example, but they are illustrated in the form of a flow chart in FIG. 12 to make it easy to understand the details of the process.

The script template data 580 may include an initial process template 581 and an event process template 582.

The initial process template 581 may be defined as a template for generating a part of the script data (hereinafter, referred to as “initial process script”) defining an initial process to be executed first by the script executing section 230 when the browser apparatus 200 reads the HTML data.

The event process template 582 may be defined as a template for generating a part of the script data (hereinafter, referred to as an “event process script”) defining a process to be executed by the script executing section 230 when an event occurs.

The initial process template 581 and the event process template 582 may include at least one blank space 503 and 504, respectively. The script generating section 122 embeds data extracted from the configuration information data 510 and the event information data 530 in the blank spaces 503 and 504, to generate the script data 590.

With this specific example, the initial process template 581 includes an event setting template 583, a screen component request transmitting template 584, a screen component receiving template 585, and a screen component displaying template 586.

The event setting template 583 may be defined as a template for generating a script of a step for initializing to monitor the occurrence of an event. The event setting template 583 includes three blank spaces 503a to 503c. For each event of a condition for starting a process, the script generating section 122 generates data (hereinafter referred to as “event setting script”) by embedding data in the blank spaces 503a to 503c of the event setting template 583, by using the CPU 911. Specifically, the blank space 503a is filled with data for specifying an element being a target to be monitored for the occurrence of an event, for example. The script generating section 122 may calculate data for specifying the element being the target to be monitored for the occurrence of an event, based on the event target 543 extracted from the condition definition data 541 included in the event information data 530. The blank space 503b is filled with the event type 542 extracted from that condition definition data 541, for example. The blank space 503c is filled with data (e.g., a function name) for specifying the process to be executed when that event occurs, for example. The script generating section 122 may generate data for specifying the process to be executed when that event occurs, by using the CPU 911, based on the name 532 of the control definition data 531 including that condition definition data 541. Since the event information data 530 includes three items of the condition definition data 541a to 541c, the script generating section 122 generates three event setting scripts corresponding to them.

The screen component request transmitting template 584 may be defined as a template for generating a script of a step for transmitting to the web server apparatus 100 the screen component request requesting a screen component to be displayed at beginning. The screen component receiving template 585 may be defined as a template for generating a script of a step for receiving the screen component data transmitted by the web server apparatus 100. The screen component displaying template 586 may be defined as a template for generating a script of a step for displaying the screen component based on the received screen component data. The screen component request transmitting template 584 has one blank space 503d provided. The screen component receiving template 585 has no blank space provided. The screen component displaying template 586 has one blank space 503e provided. For each screen component having the resource 515 in the component information data 510, the script generating section 122 may generate three items of data (hereinafter, referred to as a “screen component request transmitting script”, a “screen component receiving script” and a “screen component displaying script”) by filling the blank spaces 503d and 503e included in the screen component request transmitting template 584, the screen component receiving template 585, and the screen component displaying template 586. Specifically, the blank space 503d is filled with the resource 515 extracted from the screen component definition data 511 included in the configuration information data 510. The blank space 503e is filled with the name 512 of the screen component extracted from that screen definition data 511. Since out of the items of the screen component definition data 511, only one item of the screen component definition data 511a has the resource 515 specified, the script generating section 122 generates one set of the screen component request transmitting script, the screen component receiving script, and the screen component displaying script, corresponding to it.

The script generating section 122 may combine the generated event setting script, the generated screen component request transmitting script, the generated screen component receiving script, and the generated screen component displaying script, by using the CPU 911, thereby generating an initial process script 591.

With this specific example, the event process template 582 includes a screen component request transmitting template 587, a screen component receiving template 588, and a screen component displaying template 589. The screen component request transmitting template 587 may be defined as a template for generating a script of a step for transmitting the screen component request to the web server apparatus 100 when an event occurs. The screen component receiving template 588 may be defined as a template for generating a script of a step for receiving the screen component data transmitted by the web server apparatus 100. The screen component displaying template 589 may be defined as a template for generating a script of a step for displaying the screen component based on received screen component data. The event process template 582 has a blank space 504a provided. The screen component request transmitting template 587 has three blank spaces 504b to 504d provided. The screen component receiving template 588 has no blank space provided. The screen component displaying template 589 has a blank space 504e provided. The blank space 504a is filled with data (e.g., a function name) that specifies a process to be executed when an event occurs. The script generating section 122 may fill the blank space 504a with the corresponding data generated to be embedded in the blank space 503c. The blank space 504b is filled with the request destination data 554 extracted from the event definition data 533. The blank space 504c is filled with the transmission method type 552 extracted from that event definition data 533. The blank space 504d is filled with the parameter type 555 extracted from that event definition data 533. The blank space 504e is filled with the processing target component 558 extracted from that event definition data 533. Since the event information data 530 includes two items of the event definition data 533a and 533b, the script generating section 122 may generate two event process scripts 592a and 592b corresponding to them.

The script generating section 122 may combine the generated initial process script 591 and the two event process scripts 592a and 952b, thereby thus generating the script data 590.

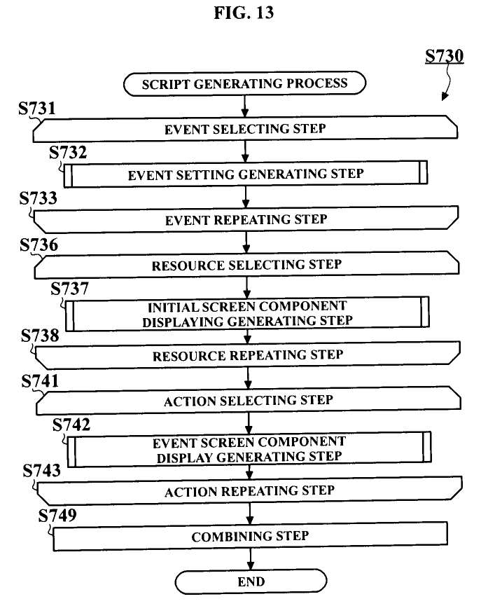

FIG. 13 shows a flow chart illustrating an example flow of a script generating process S730 according to this embodiment.

In the script generating process S730, the script generating section 122 generates the script data 590. The script generating process S730 may include an event selecting step S731, an event setting generating step S732, an event repeating step S733, a resource selecting step S736, an initial screen component displaying generating step S737, a resource repeating step S738, an action selecting step S741, an event screen component displaying generating step S742, an action repeating step S743, and a combining step S749.

In the event selecting step S731, the script generating section 122 selects one item at a time of the condition definition data 541, by using the CPU 911, from among the event information data 530 stored by the event information storing section 113.

In the event setting generating step S732, the script generating section 122 makes a copy of the event setting template 583 stored by the script template storing section 115, by using the CPU 911, for the condition definition data 541 selected in the event selecting step S731. The script generating section 122 then fills the blank spaces 503a to 503c provided in the copied event setting template 583 with data generated based on a string extracted from the condition definition data 541 selected in the event selecting step S731, by using the CPU 911, thereby thus generating the event setting script.

In the event repeating step S733, the script generating section 122 determines whether there is an item of the condition definition data 541 being left unselected in the event selecting step S731, by using the CPU 911. If it is determined that there is an item being left unselected of the condition definition data 541, then the script generating section 122 returns to the event selecting step S731, by using the CPU 911, to select the next item of the condition definition data 541. If it is determined that every item of the condition definition data 541 has been selected, then the script generating section 122 proceeds to the resource selecting step S736, by using the CPU 911.

In the resource selecting step S736, the script generating section 122 selects an item at a time of the screen component definition data 511 with the resource 515 specified, by using the CPU 911, from among the configuration information data 510 stored by the configuration information storing section 111.

In the initial screen component displaying generating step S737, the script generating section 122 makes a copy of the screen component request transmitting template 584, the screen component receiving template 585, and the screen component displaying template 586 stored by the script template storing section 115, by using the CPU 911, for the screen component definition data 511 selected in the resource selecting step S736. The script generating section 122 then generates the screen component request transmitting script, the screen component receiving script, and the screen component displaying script by filling the blank spaces 503d and 503e included in the screen component request transmitting template 584, the screen component receiving template 585, and the screen component displaying template 586 with data generated based on a string extracted from the screen component definition data 511 selected in the initial screen component displaying generating step S737, by using the CPU 911.

In the resource repeating step S738, the script generating section 122 determines whether there is an item of the screen component definition data 511 being left unselected in the resource selecting step S736, by using the CPU 911. If it is determined that there is an item being left unselected of the screen component definition data 511, then the script generating section 122 returns to the resource selecting step S736, by using the CPU 911, to select the next item of the screen component definition data 511. If it is determined that every item of the screen component definition data 511 with the resource 515 specified has been selected, then the script generating section 122 combines scripts generated in the event setting generating step S732 and the initial screen component displaying generating step S737 as the initial process script 591, by using the CPU 911. The process then proceeds to the action selecting step S741.

In the action selecting step S741, the script generating section 122 selects one item at a time of the event definition data 533, by using the CPU 911, from among the event information data 530 stored by the event information storing section 113.

In the event screen component displaying generating step S742, the script generating section 122 makes a copy of the event process template 582 stored by the script template storing section 115, by using the CPU 911, for the event definition data 533 selected in the action selecting step S741. The script generating section 122 then generates the event process script 592 by filling the blank spaces 504a to 504e of the copied event process template 582 with data generated based on a string extracted from the event definition data 533 selected in the action selecting process S741, by using the CPU 911.

In the action repeating step S743, the script generating section 122 determines whether there is an item of the event definition data 533 being left unselected in the action selecting step S741, by using the CPU 911. If it is determined that there is an item being left unselected of the event definition data 533, then the script generating section 122 returns to the action selecting step S741, by using the CPU 911, to select the next event definition data 533. If it is determined that every item of the event definition data 533 has been selected, then the script generating section 122 proceeds to the combining step S749, by using the CPU 911.

In the combining step S749, the script generating section 122 combines the generated initial process script 591 and the generated event process script 592, by using the CPU 911, thereby thus generating the script data 590.

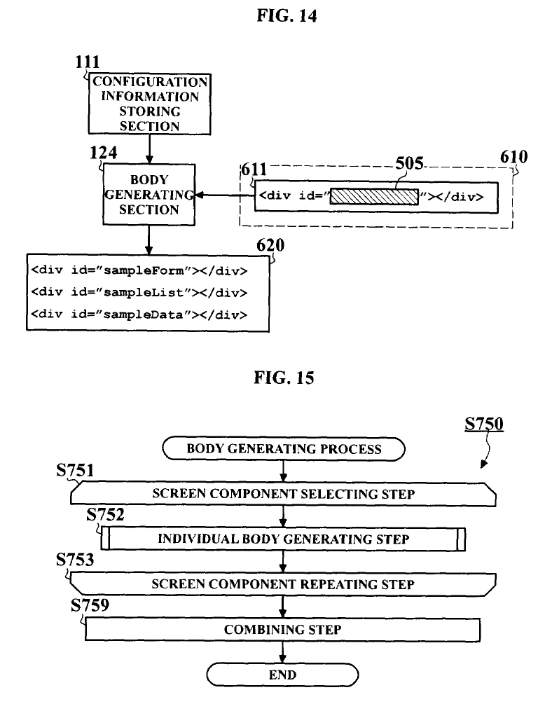

FIG. 14 shows examples of body template data 610 and body data 620 according to the first embodiment.

The body template data 610 may include individual body template data 611, for example.

The individual body template data 611 may be defined as a template for generating a part of the body data relating to each screen component. The individual body template data 611 may include at least one blank space 505. The body generating section 124 may generate the body data 620 by filling the blank space 505 with a string extracted from the configuration information data 510. The individual body template data 611 has one blank space 505 in this specific example.

With this specific example, the body generating section 124 generates data (hereinafter, referred to as “individual body data”) with the blank space 505 of the individual body template 611 filled with data, for each screen component, by using the CPU 911. The blank space 505 is filled with the name 512 of the screen component extracted from the configuration information data 510. Since the configuration information data 510 includes three items of the screen component definition data 511a to 511c, the body generating section 124 may generate three items of the individual body data, corresponding to them.

The body generating section 124 may combine the generated items of the individual body data, thereby thus generating the body data 620.

FIG. 15 shows a flow chart illustrating an example flow of a body generating process S750 according to the first embodiment.

In the body generating process S750, the body generating section 124 generates the body data 620. The body generating process S750 may include a screen component selecting step S751, an individual body generating step S752, a screen component repeating step S753, and a combining step S759.

In the screen component selecting step S751, the body generating section 124 selects one at a time of the screen component definition data 511, by using the CPU 911, from among the configuration information data 510 stored by the configuration information storing section 111.

In the individual body generating step S752, the body generating section 124 makes a copy of the individual body template data 611 stored by the body template storing section 117, by using the CPU 911, for the screen component definition data 511 selected in the screen component selecting step S751. The body generating section 124 fills the blank space 505 of the copied individual body template data 611 with a string extracted from the screen component definition data 511 selected in the screen component selecting step S751, by using the CPU 911, thereby thus generating the individual body data.

In the screen component repeating step S753, the body generating section 124 determines whether there is an item of the screen component definition data 511 being left unselected in the screen component selecting step S751, by using the CPU 911. If it is determined that there is an item being left unselected of the screen component definition data 511, then the body generating section 124 returns to the screen component selecting step S751, by using the CPU 911, to select the next item of the screen component definition data 511. If it is determined that every item of the screen component definition data 511 has been selected, then the body generating section 124 proceeds to the combining step S759, by using the CPU 911.

In the combining step S759, the body generating section 124 combines the items of the individual body data generated in the individual body generating step S752, thereby thus generating the body data 620.

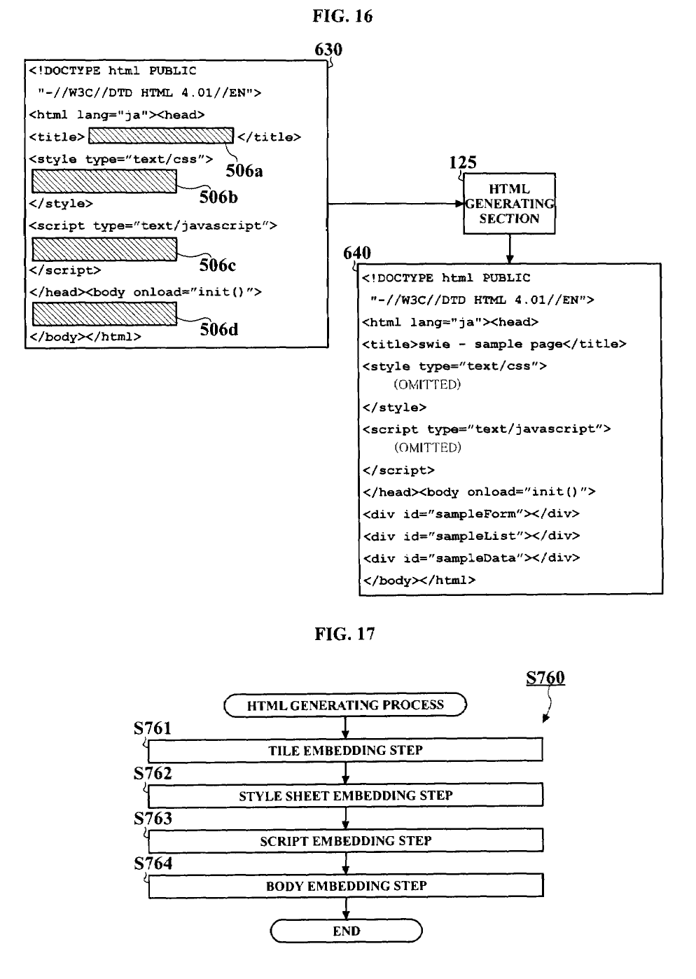

FIG. 16 shows examples of HTML template data 630 and HTML data 640 according to this embodiment.

The HTML template data 630 may include at least one blank space 506. The HTML generating section 125 may fill the blank space 506 of the HTML template data 630 with data, thereby generating the HTML data 640. With this specific example, the HTML template data 630 has four blank spaces 506a to 506d provided.

The blank space 506a is filled with the title extracted from the configuration information data 510, for example. The blank space 506b is filled with the style sheet data 570 generated by the style sheet generating section 121, for example. The blank space 506c is filled with the script data 590 generated by the script generating section 122 is embedded, for example. The blank space 506d is filled with the body data 620 generated by the body generating section 124, for example.

FIG. 17 shows a flow chart illustrating an example flow of an HTML generating process S760 according to this embodiment.

In the HTML generating process S760, the HTML generating section 125 generates the HTML data 640. The HTML generating process S760 may include a tile embedding step S761, a style sheet embedding step S762, a script embedding step S763, and a body embedding step S764.

In the tile embedding step S761, the HTML generating section 125 makes a copy of the HTML template data 630 stored by the HTML template storing section 118, by using the CPU 911. The HTML generating section 125 extracts the title from the configuration information data 510 stored by the configuration information storing section 111, by using the CPU 911. The HTML generating section 125 fills the blank space 506a of the copied HTML template data 630 with the title extracted, by using the CPU 911.

In the style sheet embedding step S762, the HTML generating section 125 fills the blank space 506b of the copied HTML template data 630 with the style sheet data 570 generated by the style sheet generating section 121, by using the CPU 911.

In the script embedding step S763, the HTML generating section 125 fills the blank space 506c of the copied HTML template data with the script data 590 generated by the script generating section 122, by using the CPU 911.

In the body embedding step S764, the HTML generating section 125 fills the blank space 506d of the copied HTML template data 630 with the body data 620 generated by the body generating section 124. The HTML generating section 125 then output the HTML template data 630 with all the blank spaces filled with data as the HTML data 640, by using the CPU 911.

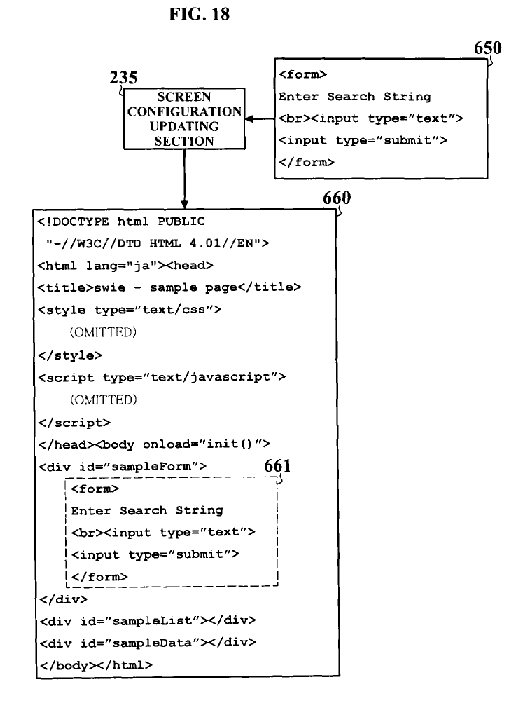

FIG. 18 shows examples of screen component data 650 and screen configuration data 660 according to this embodiment.

It should be noted that the screen configuration data 660 written in the HTML format with this specific example may be stored in an converted form into an internal expression format by the screen configuration storing section 216.

Referring to the browser apparatus 200, the HTML receiving section 211 receives the HTML data transmitted by the web server apparatus 100 to the browser apparatus 200, and the script executing section 230 executes the script data 590. Accordingly, the script executing section 230, as the component request transmitting section 233, transmits the screen component request to the web server apparatus 100 and, as the screen component receiving section 234, receives the screen component data 650 transmitted by the web server apparatus 100.

The screen component data 650 is text data written in an HTML format, for example. The screen component data 650 is not however completely formatted such as the HTML data 640, but an HTML segment representing one or a plurality of elements. With this specific example, the screen component data 650 indicates a “form” element including elements such as an “input” element.

The script executing section 230, as the screen configuration updating section 235, updates the screen configuration data 660 stored by the screen configuration storing section 216 based on the screen component data 650 received as the screen component receiving section 234, by using the CPU 911. More specifically, the screen configuration updating section 235 pastes the screen component data 650 as content 661 of a “div” element specified, for example. The display screen image generating section 217 generates the display screen image based on the updated screen configuration data 660, and the screen image displaying section 218 displays it, thereby thus displaying the screen component based on the screen component data 650.

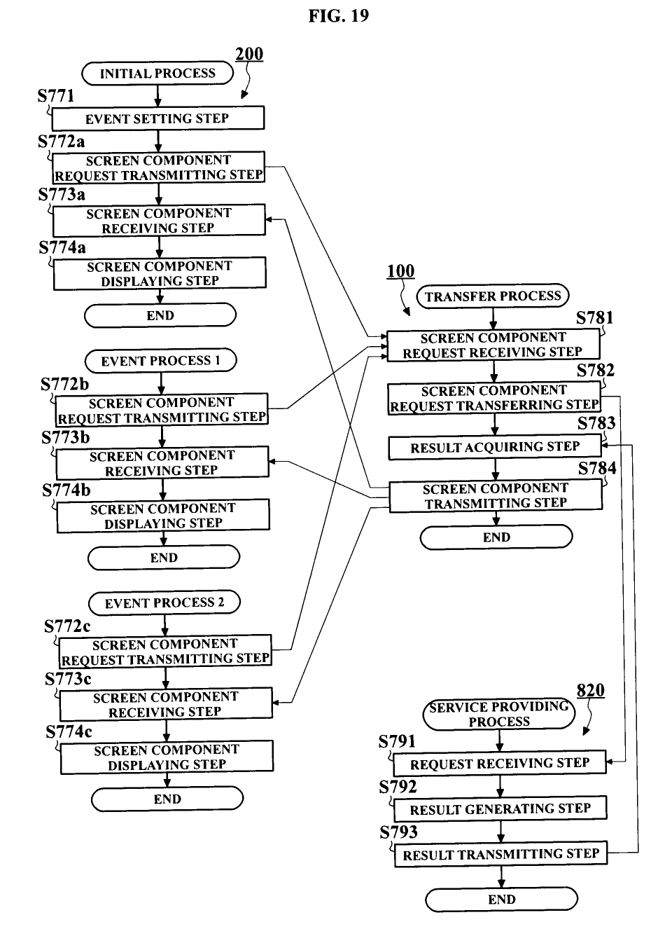

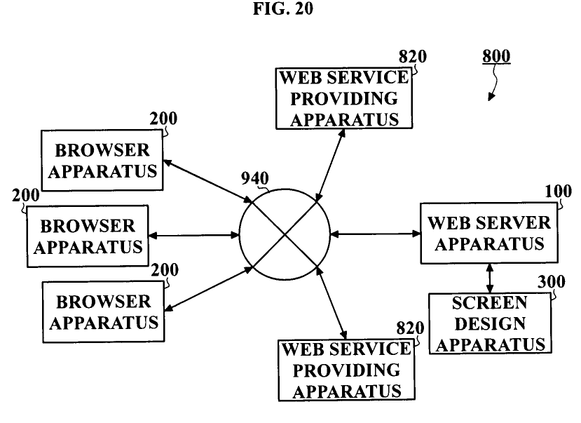

FIG. 19 shows a flow chart illustrating an example flow of a screen component generating/displaying process according to this embodiment.

The browser apparatus 200 receives the HTML data 640 transmitted by the web server apparatus 100 to the browser apparatus 200, acquires the script data 590 from the received HTML data 640, and executes the acquired script data 590, thereby performing processes, such as an initial process, an event process 1, and an event process 2.

The initial process may include an event setting step S771, a screen component request transmitting step S772a, a screen component receiving step S773a, and a screen component displaying step S774a, for example.

The event process 1 may include a screen component request transmitting step S772b, a screen component receiving step S773b, and a screen component displaying step S774b.

The event process 2 may include a screen component request transmitting step S772c, a screen component receiving step S773c, and a screen component displaying step S774c.

The web server apparatus 100 performs a transfer process. The transfer process may include a screen component request receiving step S781, a screen component request transferring step S782, a result acquiring step S783, and a screen component transmitting step S784.

The web service providing apparatus 820 may perform a service providing process. The service providing process may include a request receiving step S791, a result generating step S792, and a result transmitting step S793.

In the event setting step S771, the script executing section 230 sets an event being a condition for starting the process as a monitoring target, by using the CPU 911. The event determining section 222 monitors whether an event set as the monitoring target occurs or not, and notify the script executing section 230 when the event occurs, by using the CPU 911. The script executing section 230, upon receipt of the notification, executes a process to be executed in response to the event occurred, such as the event process 1 and the event process 2.

In the screen component request transmitting steps S772a to S772c, the parameter setting section 231 sets a parameter, by using the CPU 911. The component request generating section 232 generates the screen component request based on the parameter set by the parameter setting section 231, by using the CPU 911. The component request transmitting section 233 transmits the screen component request generated by the component request generating section 232 to the web server apparatus 100, by using the communication device 915.

In the screen component request receiving step S781, the component request receiving section 183 receives the screen component request transmitted by the browser apparatus 200 to the web server apparatus 100, by using the communication device 915.

In the screen component request transferring step S782, the component providing source determining section 142 determines to which of the web service providing apparatuses 820 the screen component request received by the component request receiving section 183 in the screen component request receiving step S781 is to be transferred, by using the CPU 911. The web service calling section 143 transfers the screen component request received by the component request receiving section 183 in the screen component request receiving step S781 to the web service providing apparatus 820 determined by the component providing source determining section 142, by using the communication device 915.

In the request receiving step S791, the web service providing apparatus 820 receives the screen component request transferred to the web service providing apparatus 820 by the web server apparatus 100 in the screen component request transferring step S782.

In the result generating step S792, the web service providing apparatus 820 provides a web service based on the screen component request received in the request receiving step S791, and generates result data indicating the result of the provided web service.

In the result transmitting step S793, the web service providing apparatus 820 transmits the result data generated in the result generating step S792 to the web server apparatus 100.

In the result acquiring step S783, the result acquiring section 144 receives the result data transmitted by the web service providing apparatus 820 in the result transmitting step S793, by using the communication device 915. The screen component generating section 145 treats the result data received by the result acquiring section 144 as the screen component data 650, by using the CPU 911, in the case that the web service providing apparatus 820 is configured to return the result data available as the screen component without modification.

In the screen component transmitting step S784, the screen component transmitting section 184 transmits the screen component data 650 generated by the screen component generating section 145 in the result acquiring step S783 to the browser apparatus 200, by using the communication device 915.

In the screen component receiving steps S773a to S773c, the screen component receiving section 234 receives the screen component data 650 transmitted to the browser apparatus 200 by the web server apparatus 100.

In the screen component displaying steps S774a t S774c, the screen configuration updating section 235 updates the screen configuration data 660 stored by the screen configuration storing section 216 based on the received screen component data 650, by using the CPU 911. The screen component generating section 217 generates a display screen image based on the screen configuration data 660 updated by the screen configuration updating section 235. The screen image displaying section 218 displays the display screen image generated by the display screen image generating section 217, by using the display 901.

In the screen display program generating apparatus of the present invention, the layout generating section may generate the layout program based on the layout information data. The layout program is for causing the screen display apparatus to provide the display area for displaying the screen component in advance. The component display generating section may generate the component display program based on the event information data 530. The component display program is for causing the screen display apparatus to acquire and display the screen component when a condition such as the occurrence of an event is satisfied. Therefore, the screen display program generating apparatus may automatically generate the screen display program.

The code generating section 110 according to this embodiment may be a screen display program generating apparatus that generates a screen display program (the HTML data 640) that causes the screen display apparatus (the browser apparatus 200) to display the display screen image that is made up by a screen component provided by a screen component providing apparatus (the web service providing apparatus 820).

The screen display program generating apparatus may include a memory for storing data (the magnetic disk drive 920), a processor for processing data (the CPU 911), the layout information storing section 112, the event information storing section 113, a layout generating section (the style sheet generating section 121, the body generating section 124), a component display generating section (the script generating section 122), and a screen display program generating section (the HTML generating section 125).

The layout information storing section 112 may store, by using the memory, the layout information data 520 indicating the display position at which the screen component is displayed in the display screen image.

The event information storing section 113 may store, by using the memory, the event information data 530 indicating the display condition under which the screen component is displayed at the display position.

The layout generating section may generate, by using the processor, a layout program (the style sheet data 570, the body data 620) based on the layout information data 520 stored by the layout information storing section 112. The layout program may cause the screen display apparatus to display the display area for displaying the screen component at the display position.

The component display generating section may generate a component display program (the script data 590) based on the event information data 530 stored by the event information storing section 113, by using the processor. The component display program may be defined as a program that causes the screen display apparatus to determine whether the display condition is satisfied or not (e.g., an event occurs or not), request the screen component providing apparatus to provide the screen component to be displayed in the display area if it is determined that the display condition is satisfied, and display the screen component provided by the screen component providing apparatus in the display area.

The screen display program generating section may combine the layout program generated by the layout generating section and the component display program generated by the component display generating section, by using the processor, thereby thus generating the screen display program.

The code generating section 110 (the screen display program generating apparatus) of this embodiment includes the layout generating section (the style sheet generating section 121, the body generating section 124) for generating the layout program (the style sheet data 570, the body data 620) that causes the screen display apparatus to provide the display area for displaying the screen component in advance, based on the layout information data 520, and the component display generating section (the script generating section 122) for generating the component display program (the script data 590) that causes the screen display apparatus to acquire and display the screen component if the display condition such as the occurrence of an event is satisfied, based on the event information data 530, thereby thus making it possible to generate the screen display program (the HTML data 640) automatically.

With further reference to the code generating section 110 (the screen display program generating apparatus) of this embodiment, the component display program (the script data 590) causes the screen display apparatus to transmit the screen component request to a predetermined request transfer apparatus (the transmitting/receiving section 180, the request transferring section 140), and receive the screen component provided by the screen component providing apparatus from the request transfer apparatus. The screen component request is for requesting the screen component providing apparatus (web service providing apparatus 820) to provide the screen component to be displayed in the display area.

The code generating section 110 (the screen display program generating apparatus) of this embodiment includes the component display generating section (the script generating section 122) for generating the component display program (the script data 590) that causes the screen display apparatus to transmit the screen component request to the request transfer apparatus (the transmitting/receiving section 180, the request transferring section 140) that transfers the screen component request to the screen component providing apparatus (the web service providing apparatus 820), thereby thus allowing the screen component request to be transmitted to the screen component providing apparatus, even if security restriction, or the like, prevents the screen display apparatus (the browser apparatus 200) from transmitting the screen component request directly to the screen component providing apparatus.

With further reference to the code generating section 110 (the screen display program generating apparatus) of this embodiment, the screen display program (the HTML data 640) may be text data in an HTML format.

The component display program (the script data 590) may cause the screen display apparatus to receive text data in an HTML format indicating an HTML element, as data indicating the screen component (the screen component data), and generate the screen component based on the received text data.

With further reference to the code generating section 110 (the screen display program generating apparatus) of this embodiment, the screen display program is the text data in an HTML format, and the component display program is for receiving the text data in an HTML format indicating an HTML element, as data indicating the screen component, thereby thus facilitating the display of the screen component. This may allow for a reduction of the load on the client side, that is, the screen display apparatus (the browser apparatus 200).

The screen display system 800 according to this embodiment includes the screen component providing apparatus (the web service providing apparatus 820).

The screen component providing apparatus provides the screen display apparatus with the screen component, upon request from the screen display apparatus (the browser apparatus 200).

The screen display system 800 of this embodiment includes the screen component providing apparatus (the web service providing apparatus 820) for providing the screen component, and the screen display apparatus (the browser apparatus 200) for making up the display screen image 400 based on the screen component provided by the screen component providing apparatus, thereby thus facilitating the building of the display screen image 400.

The code generating section 110 (the screen display program generating apparatus) of this embodiment may be implemented by using a computer having a memory for storing data (the magnetic disk drive 920) and a processor for processing data (the CPU 911), and a computer program that causes the computer to function as the screen display program generating apparatus. That is, it may be implemented by the computer's execution of the computer program.

The computer program of this embodiment may realize the screen display program generating apparatus (code generating section 110) that includes the layout generating section (the style sheet generating section 121, the body generating section 124) for generating the layout program (the style sheet data 570, the body data 620) that causes the screen display apparatus to provide the display area for displaying the screen component in advance, based on the layout information data 520, and the component display generating section (the script generating section 122) for generating the component display program (the script data 590) that causes the screen display apparatus to acquire and display the screen component when the condition such as the occurrence of an event is satisfied, based on the event information data 530, thereby thus making it possible to generate the screen display program (the HTML data 640) automatically.

A screen display program generating method for the code generating section 110 (the screen display program generating apparatus) of this embodiment to generate the screen display program (the HTML data 640) that causes the screen display apparatus (the browser apparatus 200) to display the display screen image built by the screen component that is provided by the screen component providing apparatus (the web service providing apparatus 820) may be performed as follows:

The processor (the CPU 911) generates the layout program (the style sheet data 570, the body data 620) based on the layout information data 520 indicating the display position at which the screen component is displayed in the display screen image. The layout program causes the screen display apparatus to display the display area for displaying the screen component at the display position.

The processor generates the component display program (the script data 590) based on the event information data 530 indicating the display condition for displaying the screen component at the display position. The component display program causes the screen display apparatus to determine whether the display condition is satisfied or not (e.g., an event occurs or not), request the screen component providing apparatus to provide the screen component to be displayed in the display area if the display condition is satisfied, and display the screen component provided by the screen component providing apparatus in the display area.

The processor combines the generated layout program and the generated component display program, thereby thus generating the screen display program.

The screen display program generating method of this embodiment generates the layout program (the style sheet data 570, the body data 620) that causes the screen display apparatus to provide the display area for displaying the screen component in advance, based on the layout information data 520, and generates the component display program (the script data 590) that causes the screen display apparatus to acquire and display the screen component if the condition such as the occurrence of an event is satisfied, based on the event information data 530, thereby thus making it possible to generate the screen display program (the HTML data 640) automatically.

The web server apparatus 100 described hereinbefore is a web service integrating apparatus capable of integrating web services and automatically generating a dynamic web screen image involving a web service operation.

The web service integrating apparatus may build a screen image to be displayed on the web browser apparatus 200 by the layout and the screen component.

A screen component service providing section (the request transferring section 140, the web service providing apparatus 820) provides the screen component with display information.

An integrated screen definition information storing section (the configuration information storing section 111, the layout information storing section 112, the event information storing section 113) holds the layout information data 520 of an integrated screen image and the event information data 530 describing correspondence among a screen event, a screen component service, and a result destination screen component.

A web screen automatic generation section (the style sheet generating section 121, the script generating section 122, the body generating section 124, the HTML generating section 125) generates a web screen image automatically based on set integrated screen definition information.

The web browser apparatus 200 notifies a web integration server (the web server apparatus 100) of an event of the screen image.

A service calling section (the request transferring section 140) calls a corresponding screen component service based on the event, and returns the content of a result.

The web browser apparatus 200 replaces a part of the screen image with the received content.

This may allow for an easy change in the display of a screen image.

An integrated screen generating section (the style sheet generating section 121, the script generating section 122, the body generating section 124, the HTML generating section 125) generates an integrated screen image (the HTML data 640) as a web screen image based on the integrated screen definition information (the configuration information data 510, the layout information data 520, the event information data 530). The integrated screen generating section converts the integrated screen definition information to generate a generated screen component as an element to build the integrated screen image, a screen layout determining the position and the size of each screen component of the integrated screen image, and an event control function program, and integrates those elements, thereby thus generating the integrated screen image.

It is to be noted that the format of the converted data of the definition information should allow generated elements to generate a web screen image when they are integrated. For example, a div element, a Cascade Style Sheet (CSS), and a JavaScript (trademark) are available for the screen component, the screen layout, and an event control function program, respectively, which are however not exclusively recommended.

A service transferring section (the request transferring section 140) receives a request from the web browser apparatus 200 that executes the event control function program (the script data 590) in the integrated screen image (the HTML data 640), transfers the request to a specified web service, and then transfers a response from the web service to the web browser apparatus 200. Under the restriction that the request for a web service is allowed to be transmitted exclusively to the host that has generated the integrated screen image, for example, the request may be transferred to the screen component service providing section (the web service providing apparatus 820) from the web integration server (the web server apparatus 110), thereby making it possible to call a web service.

The screen component service providing section provides a screen component service for returning screen display information (the screen component data 650) as a response upon request. The screen display information is used for displaying a screen in the web browser apparatus 200. The screen display information is a source code, including but not limited to an HTML source code, an XML source code, or a part of those source codes, for example. Not only a newly generated source code, but also a part of the source code of an existing web system may be used as well. The screen display information is not limit to these examples.

It should be noted that the response of a web service returning data alone (hereinafter, referred to as a “data service”) may be internally processed and used as part of the screen display information. This may be applied in the case of displaying a chart made of a data service response, for example.

The integrated screen definition information (the configuration information data 510, the layout information data 520, the event information data 530) is a setting for combining screen component services, and includes definition information for generating an integrated screen image.

The integrated screen definition information may be roughly divided into a display information part (the layout information data 520) for displaying a screen image on the browser and an action information part (the event information data 530) for performing a process in response to a user's screen operation. The display information part and the action information part themselves have no relation to each other. The integrated screen definition information also includes screen component information (the configuration information data 510) for combining them. Those three items of information together may allow for an automatic generation of a dynamic integrated screen image. The integrated screen definition information may be described in a format including but not limited to an XML format, for example.

The layout information data 520 defining the display information part includes setting elements, such as the position of the screen component and the size of the screen component within the integrated screen image, to display the web screen image.

The layout definition data 521 defines screen layout used for different screen components. The layout definition data 521 includes data indicating the position (the top position 523, the left position 524) of the screen component within the integrated screen image, and data indicating the size (the width 525, the height 526) of the screen component.

The event information data 530 defining the action information part may include setting elements such as a user's operation within the screen component, a process corresponding to the user's operation, an acquiring web service URI, an acquisition source of a parameter, and a destination of an output response. If the destination of a response executed upon request from one screen component is set to another screen component, then those different screen components may be linked together.

For example, if inputting a search string in an entry form in a screen component having a search function and then executing it, then a screen image showing a search result may be displayed in another screen component. Specifically, when a user clicks the submit button or presses the enter key for a screen component as the input source, the web browser apparatus 200 in execution of the event control function program transmits a string inputted in a form to a specified web service, and then sends data returned back to another screen component as the output destination. More specifically, the event information data 530 may be set with “click submit button” and “press enter key” for the user's operation, “submit” for a process corresponding to the user's operation, “URI of specified web service” for an acquiring web service URI, “form” for an acquisition source of a parameter, and “another screen component” for a destination of an output response.

For example, the following text strings may be selected for specifying the above settings within an event information source code (the event information data 530): “type=‘click’ xpath=‘form [1]/input [2]’” for the user's operation, “http://host2/service/search” for the acquiring web service URI, “form” for the acquisition source of the parameter, and “sampleList” for the destination of an output response.

The screen component information (configuration information data 510) may include setting elements such as the name of the screen component (the name 512), the element of action information used within the screen component (the control 514), and layout information (the layout 513) applied to the screen component. A screen component service to be displayed as a screen component may be defined in the event information. The screen component information may define a link between the action information and the display information.

The source code of the screen component information (the configuration information data 510) may include the screen component definition data 511 for each screen component. The following strings may be used to specify the setting of screen components: “sampleForm” for the name of a screen component, “sampleFormLayout” for the definition of a layout to be used, and “sampleFormControl” for the definition of an event to be used.

The integrated screen image (the HTML data 640) may be generated automatically based on the integrated screen definition information. When the web browser apparatus 200 displays an integrated screen image, then a screen image obtained by combining screen components based on the integrated screen definition information is displayed.

The screen component may be generated by the integrated screen generating section as a part of the integrate screen image based on the integrated screen definition information. The screen component is the embedding destination of the screen display information acquired from the screen component service. Usually, two or more screen components are provided.

A screen component may include component elements such as a div element for a screen component, a layout attribute for a screen layout, and a control attribute for the event control function program, for example. The screen component service may be embedded into the div element in the form of a content or the like.

The event control function program (the script data 590) causes a computer to perform a process in response to a user's operation on a screen component. The event control function program may be generated automatically by the integrated screen generating section converting the event information data 530 defining the action information part of the integrated screen definition information. The result of conversion of the event information may include but not limited to JavaScript (trademark).

The web service integrating apparatus (the web server apparatus 100) may generate an integrated screen image (the HTML data 640), and provide a web service based on a user's screen operation.

When the web service integrating apparatus is executed, then the integrated screen generating section may generate an integrated screen image (the HTML data 640). When the user accesses the integrated screen image for the first time, the web browser apparatus 200 displays the display screen information of the screen component service based on the integrated screen image (the HTML data 640). When the user manipulates a screen component within an integrated screen image, then the web service integrating apparatus returns a response (the screen component data 650) from the screen component service to the web browser apparatus 200. With the initial access to an integrated screen image (the HTML data 640), the reading of the integrated screen image triggers the execution of the event information control program (the script data 590) by the web browser apparatus 200, to acquire a web service without involving a user's operation.

An operation of the web service integrating apparatus for generating the integrated screen image (the HTML data 640) may be described as follows:

The integrated screen generating section, upon execution of the web service integrating apparatus, may read the screen component information (the configuration information data 510) of the integrated screen definition information to generate a screen component (the body data 620). The integrated screen generating section may read the layout information data 520 of the integrated screen definition information to generate a layout (the style sheet data 570) for an integrated screen image. The integrated screen generating section may read the event information data 530 of the integrated screen definition information to generate the event control function program (the script data 590). The integrated screen generating section may generate an integrated screen image (the HTML data 640) based on the generated screen component, the generated screen layout, and the generated event control function program. The web service integrating apparatus may hold a cache therein for integrated screen images generated by the integrated screen generating section, and transmit an integrated screen image, upon request from the web browser apparatus 200. Alternatively, however, the web service integrating apparatus may not hold such a cache, but generate the integrated screen image upon request from the web browser apparatus 200 by a user accessing the address of the integrated screen image, or the like.

The following describes an operation performed when a user accesses an integrated screen image for the first time, for example.

The user issues an acquisition request of an integrated screen image (the HTML data 640) to the web integrated server (the web server apparatus 100) via the browser apparatus 200. In the integration server, the integrated screen generating section generates the integrated screen image, and returns the integrated screen image to the browser apparatus 200. The browser apparatus 200 executes the event control function program (the script data 590) to issue a request for the screen component to be displayed at the beginning to a set service. The browser apparatus 200 in execution of the event control function program outputs the request (the screen component request) to the request transferring section (the transmitting/receiving section 180). The service transferring section (the request transferring section 140) transfers the received request to the screen component service providing section (the web service providing apparatus 820). When the screen component service providing section uses a data service as display data, the screen component service providing section sends the request to a data service providing section (another web service providing apparatus 820) and generates its own response by integrating the response of the data service providing section into its own display screen information. The screen component service providing section returns the response to the request transferring section 140 in the web integration server. The request transferring section (the transmitting/receiving section 180) returns a returned value from the web service to the browser apparatus 200 in execution of the event control function program. The browser apparatus 200 in execution of the event control function program updates the screen component 410 based on the data returned from the request transferring section. The browser apparatus 200 updates the integrated screen image (the display screen image 400).

The following describes an operation performed when a user manipulates the screen component, for example.

The user manipulates the screen component 410 displayed within the integrated screen image (the display screen image 400) via the browser apparatus 200. The browser apparatus 200 may execute the event control function program (the script data 590) upon request corresponding to the user's operation. The following operation is the same as that performed when the user made the first access to the integrated screen image. It should be noted that this operation is usually repeated twice or more. For example, searches may be carried out twice or more for a screen component having a search function.

Thus, the definition information including the display information part (the layout information data 520) for displaying a screen image on the browser apparatus 200, the action information part (the event information data 530) for performing a process in response to the user's operation on the screen image, and the screen component information (the configuration information data 510) for combining those items of information may allow for an automatic generation of an integrated web screen image that is available as a display and operation screen for a web service, without coding involved.

The definition information may be set so that a response from the web service executed upon request from one screen component is returned to another screen component. This may allow for a dynamic linking of web services.

The web service integration apparatus described above may allow a web service to be displayed as a web screen image, without the need for a manual preparation of screen display source codes. The elimination of the need for the manual preparation of screen display source codes may also eliminate the re-coding of screen display source codes when a web service is changed, thereby allowing for immediacy maintained.

### Embodiment 2

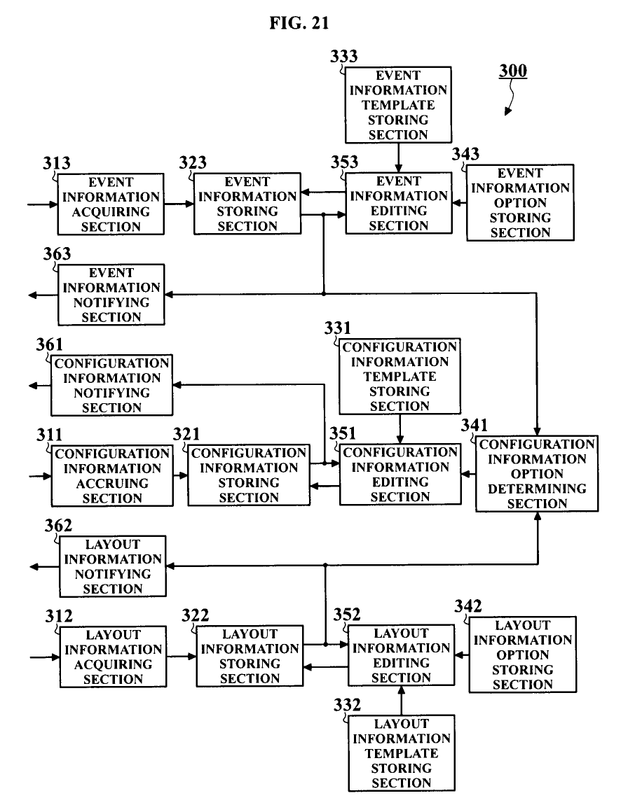

A second embodiment is now described with reference to FIG. 20 and FIG. 21.

It should be noted that the same elements as those of the screen display system 800 described in the first embodiment are assigned the same reference numerals, and will not be described here in detail.

FIG. 20 shows an example of the overall system configuration of a screen display system 800 according to this embodiment.

The screen display system 800 of this embodiment modifies the screen display system 800 described in the first embodiment by adding a screen design apparatus 300.

The screen design apparatus 300 may generate the configuration information data 510, the layout information data 520, and the event information data 530 based on the operation of a user designing the display screen image 400. The web server apparatus 100 may store the configuration information data 510, the layout information data 520, and the event information data 530, which are generated by the screen design apparatus 300.

The screen design apparatus 300 may further read and modify the configuration information data 510, the layout information data 520, and event information data 530 stored by the web server apparatus 100, based on the operation of a user designing the display screen image 400. The web server apparatus 100 may store the configuration information data 510, the layout information data 520, and the event information data 530, which are modified by the screen design apparatus 300.

The physical view and the hardware configuration of the screen design apparatus 300 are the same as those of the web server apparatus 100. It should be noted that the screen design apparatus 300 and the web server apparatus 100 may share the same unit.

FIG. 21 shows a functional block diagram illustrating an example configuration of a screen design apparatus 300 according to this embodiment.

The screen design apparatus 300 may include a configuration information acquiring section 311, a layout information acquiring section 312, an event information acquiring section 313, a configuration information storing section 321, a layout information storing section 322, an event information storing section 323, a configuration information template storing section 331, a layout information template storing section 332, an event information template storing section 333, a configuration information option determining section 341, a layout information option storing section 342, an event information option storing section 343, a configuration information editing section 351, a layout information editing section 352, an event information editing section 353, a configuration information notifying section 361, a layout information notifying section 362, and an event information notifying section 363.

The configuration information acquiring section 311 may acquire the configuration information data 510 stored by the configuration information storing section 111 of the web server apparatus 100, by using the CPU 911.

The layout information acquiring section 312 may acquire the layout information data 520 stored by the layout information storing section 112 of the web server apparatus 100, by using the CPU 911.

The event information acquiring section 313 may acquire the event information data 530 stored by the event information storing section 113 of the web server apparatus 100, by using the CPU 911.

The configuration information storing section 321 may store the configuration information data 510 acquired by the configuration information acquiring section 311, by using the CPU 911.

The layout information storing section 322 may store the layout information data 520 acquired by the layout information acquiring section 312, by using the CPU 911.

The event information storing section 323 may store the event information data 530 acquired by the event information acquiring section 313, by using the CPU 911.

The configuration information template storing section 331 may store, in advance, data (hereinafter, referred to as “configuration information template data”) as a template for configuration information data, by using the magnetic disk drive 920. The configuration information template data may be defined as data made of the configuration information data 510 by replacing variable parts, such as the name 512, the layout 513, the control 514, and the resource 515, with blank spaces, for example.

The layout information template storing section 332 may store, in advance, data (hereinafter, referred to as “layout information template data”) as a template for layout information data, by using the magnetic disk drive 920. The layout information template data may be defined as data made of the layout information data 520 by replacing variable parts, such as the name 522, the top position 523, the left position 524, the width 525, the height 526, and the style 527, with blank spaces, for example.

The event information template storing section 333 may store, in advance, data (hereinafter, referred to as “event information template data”) as a template for event information data, by using the magnetic disk drive 920. The event information template data may be defined as data made of the event information data 530 by replacing variable parts, such as the event type 542, the event target 543, the transmission method type 552, the request destination type 553, the request destination data 554, the parameter type 555, the process type 557, and the processing target component 558, with blank spaces, for example.

The configuration information option determining section 341 may determine an option of data (hereinafter, referred to as “configuration information blank space option”) that can be inserted into the blank space of the configuration information template data stored by the configuration information template storing section 331, by using the CPU 911, based on the layout information data 520 stored by the layout information storing section 322, and the event information data 530 stored by the event information storing section 323. More specifically, the configuration information option determining section 341 may extract the name 522 of the layout definition data 521, from the layout information data 520 stored by the layout information storing section 322, by using the CPU 911, as the configuration information blank space option that can be inserted into a blank space of a part corresponding to the layout 513 of the configuration information data 510, for example.

The layout information option storing section 342 may store, in advance, an option of data (hereinafter, referred to as “layout information blank space option”) that can be inserted into the blank space of the layout information template data stored by the layout information template storing section 332, by using the magnetic disk drive 920. It should be noted that the layout information option storing section 342 may be replaced by a layout information option determining section for determining the layout information blank space option.

The event information option storing section 343 may store, in advance, an option of data (hereinafter, referred to as an “event information blank space option”) that can be inserted into the blank space of the event information template data stored by the event information template storing section 333, by using the magnetic disk drive 920. It should be noted that the event information option storing section 342 may be replaced by an event information option determining section for determining the event information blank space option.

The configuration information editing section 351 may display the configuration information data 510 stored by the configuration information storing section 321, by using the display 901, input a user's operation by using an operation inputting device, and edit the configuration information data 510 stored by the configuration information storing section 321 based on the inputted user's operation, by using the CPU 911. More specifically, the configuration information editing section 351 may assist the user's operation based on the configuration information template data stored by the configuration information template storing section 331 and the configuration information blank space option determined by the configuration information option determining section 341, by using the CPU 911. For example, when a user simply clicks a button, the configuration information editing section 351 makes a copy of the configuration information template data stored by the configuration information template storing section 331, and inserts the copy of the configuration information template data into a position specified in the configuration information data 510, by using the CPU 911. To give another example, when a user points a mouse cursor at the position of a blank space of the copy of the configuration information template data, the configuration information editing section 351 displays configuration information blank space options determined to be available in the blank space by the configuration information option determining section 341, by using the display 901. From among the displayed configuration information blank space options, the user may thus select data to be embedded in the blank space.

The layout information editing section 352 may display the layout information data 520 stored by the layout information storing section 322, by using the display 901, input a user's operation by using an operation inputting device, and edit the layout information data 520 stored by the layout information storing section 322, by using the CPU 911, based on the user's operation. More specifically, the layout information editing section 352 may assist the user's operation, by using the CPU 911, based on the layout information template data stored by the layout information template storing section 332 and the layout information blank space option stored by the layout information option storing section 342.

The event information editing section 353 may display the event information data 530 stored by the event information storing section 323, by using the display 901, input the user's operation by using the operation inputting device, and edit the event information data 530 stored by the event information storing section 323, by using the CPU 911, based on the inputted user's operation. More specifically, the event information editing section 353 may assist the user's operation, by using the CPU 911, based on the event information template data stored by the event information template storing section 333 and the event information blank space option stored by the event information option storing section 343.

The configuration information notifying section 361 may notify the web server apparatus 100 of the configuration information data 510 stored by the configuration information storing section 321, by using the CPU 911, to allow the configuration information storing section 111 of the web server apparatus 100 to store the configuration information data 510.

The layout information notifying section 362 may notify the web server apparatus 100 of the layout information data 520 stored by the layout information storing section 322, by using the CPU 911, to allow the layout information storing section 112 of the web server apparatus 100 to store the layout information data 520.

The event information notifying section 363 may notify the web server apparatus 100 of the event information data 530 stored by the event information storing section 323, by using the CPU 911, to allow the event information storing section 113 of the web server apparatus 100 to store the event information data 530.

With this specific example, the configuration information data 510, the layout information data 520 and the event information data 530 storedby the web server apparatus 100 are read, edited, and written. Alternatively, however, the configuration information data 510, the layout information data 520 and the event information data 530 stored by the web server apparatus 100 are edited directly.

It should also be noted that the configuration information editing section 351, the layout information editing section 352, and the event information editing section 353 may display the configuration information data 510, the layout information data 520, and the event information data 530, by the method of displaying original text data, displaying a figure illustrating a data structure such as a hierarchical structure, or displaying a display screen image 400 to be generated based on them, to make it easy for the user to understand what would be generated as the display screen image 400.

The screen display system 800 of this embodiment may thus include a screen display program generating apparatus (the code generating section 110) and the screen design apparatus 300.

The screen design apparatus 300 may thus generate the layout information data 520 and the event information data 530 based on a user's operation.

The layout information storing section 112 may thus store the layout information data 520 generated by the screen design apparatus 300 by using a memory (the magnetic disk drive 920).

The event information storing section 113 may thus store the event information data 530 generated by the screen design apparatus 300 by using the memory.

The screen display system 800 of this embodiment including the screen design apparatus 300 may generate the layout information data 520 and the event information data. This may thus allow for a reduction in the burden of a user designing the display screen image 400.

The web service integrating apparatus described hereinbefore may include an integrated screen design section (the screen design apparatus 300) that includes an interface allowing a user to make a graphical design of the integrated screen definition information (the configuration information data 510, the layout information data 520, the event information data 530), and generates the integrated screen definition information automatically.

The integrated screen design section (the screen design apparatus 300) may include a user interface allowing a user to make a graphical design of the integrated screen definition information, and may also generate the integrated screen definition information automatically.

More specifically, a template for data description rules in the integrated screen definition information may be prepared in advance. Data only for required elements such as a web service to be used and a numerical value of the layout may be inputted by using an editor. This may allow the integrated screen definition information to be generated automatically. If the integrated screen information is described in an XML format, the XML element of the integrated screen definition information may be displayed in a tree form. Then, setting information may be generated by adding, deleting, or modifying a sub node, an attribute, or the like at the node of the tree. This may allow for an effective modification of required elements exclusively in the template.

It is also possible to provide an editor with a verification function, which may allow for an automatic detection of typographical errors and unspecified types of elements.

The integrated screen design section may eliminate the necessity of writing all the source codes of the integrated screen definition information (the configuration information data 510, the layout information data 520, the event information data 530). All that is needed is to specify an element and input a value, thereby thus generating the integrated screen definition information.

As described earlier, only the element of the definition information may be inputted through the user interface allowing a graphical design, thereby allowing a reduction in the amount of coding compared to the case of manual preparation of all the definition information. This may allow for high productivity. In addition, the use of the editor having a verification function may prevent typographical errors from being mixed in or unacceptable sub nodes and attributes from being added erroneously.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A screen display program generating apparatus that generates a screen display program causing a screen display apparatus to display a display screen image including a screen component provided by a screen component providing apparatus, the screen display program generating apparatus comprising:
a memory for storing data;
a processor for processing data;
a layout information storing section that stores, by using the memory, layout information data indicating a display position at which the screen component is displayed in the display screen image;
an event information storing section that stores, by using the memory, event information data indicating a display condition under which the screen component is displayed at the display position;
a layout generating section that generates, by using the processor, a layout program based on the layout information data stored by the layout information storing section, the layout program causing the screen display apparatus to display at the display position a display area for displaying the screen component;
a component display generating section that generates, by using the processor, a component display program based on the event information data stored by the event information storing section, the component display program causing the screen display apparatus to determine whether the display condition is satisfied, request the screen component providing apparatus to provide the screen component to be displayed in the display area when it is determined that the display condition is satisfied, and display the screen component provided by the screen component providing apparatus in the display area; and
a screen display program generating section that combines, by using the processor, the layout program generated by the layout generating section and the component display program generated by the component display generating section for generating the screen display program.

2. The screen display program generating apparatus of claim 1, wherein the component display program causes the screen display apparatus to transmit to a predetermined request transfer apparatus a screen component request requesting the screen component providing apparatus to provide the screen component to be displayed in the display area, and receive from the request transfer apparatus the screen component provided by the screen component providing apparatus.

3. The screen display program generating apparatus of claim 1, wherein the screen display program is text data in an HTML (Hyper Text Markup Language) format, and
wherein the component display program causes the screen display apparatus to receive the text data in the HTML format indicating an HTML element as data indicating the screen component, and generate the screen component based on received text data.

4. A screen display system comprising:
the screen display program generating apparatus of claim 1; and
a screen design apparatus that generates the layout information data and the event information data, based on a user's operation,
wherein the layout information storing section stores, by using the memory, the layout information data generated by the screen design apparatus, and
wherein the event information storing section stores, by using the memory, the event information data generated by the screen design apparatus.

5. The screen display system of claim 4, further comprising: a screen component providing apparatus provides the screen display apparatus with the screen component upon request from the screen display apparatus.

6. A computer readable storage medium having stored therein a computer program for causing a computer to function as the screen display program generating apparatus of claim 1, the computer including a memory for storing data and a processor for processing data.

7. A screen display program generating method for generating a screen display program by a screen display program generating apparatus including a processor for processing data, the screen display program causing a screen display apparatus to display a display screen image including a screen component provided by a screen component providing apparatus, the screen display program generating method comprising:
generating a layout program, by the processor, based on layout information data indicating a display position at which the screen component is displayed in the display screen image, the layout program causing the screen display apparatus to display at the display position a display area for displaying the screen component;
generating a component display program, by the processor, based on event information data indicating a display condition under which the screen component is displayed at the display position, the component display program causing the screen display apparatus to determine whether the display condition is satisfied, request the screen component providing apparatus to provide the screen component to be displayed in the display area if it is determined that the display condition is satisfied, and display the screen component provided by the screen component providing apparatus in the display area; and
combining, by the processor, generated layout program and generated component display program to generate the screen display program.

8. The screen display program generating apparatus of claim 2, wherein the screen display program is text data in an HTML (Hyper Text Markup Language) format, and
wherein the component display program causes the screen display apparatus to receive the text data in the HTML format indicating an HTML element as data indicating the screen component, and generate the screen component based on received text data.

9. A screen display system comprising:
the screen display program generating apparatus of claim 2; and
a screen design apparatus that generates the layout information data and the event information data, based on a user's operation,
wherein the layout information storing section stores, by using the memory, the layout information data generated by the screen design apparatus, and
wherein the event information storing section stores, by using the memory, the event information data generated by the screen design apparatus.

10. The screen display system of claim 9, further comprising: a screen component providing apparatus provides the screen display apparatus with the screen component upon request from the screen display apparatus.

11. A screen display system comprising:
the screen display program generating apparatus of claim 3; and
a screen design apparatus that generates the layout information data and the event information data, based on a user's operation,
wherein the layout information storing section stores, by using the memory, the layout information data generated by the screen design apparatus, and
wherein the event information storing section stores, by using the memory, the event information data generated by the screen design apparatus.

12. The screen display system of claim 11, further comprising: a screen component providing apparatus provides the screen display apparatus with the screen component upon request from the screen display apparatus.

13. A screen display system comprising:
the screen display program generating apparatus of claim 8; and
a screen design apparatus that generates the layout information data and the event information data, based on a user's operation,
wherein the layout information storing section stores, by using the memory, the layout information data generated by the screen design apparatus, and
wherein the event information storing section stores, by using the memory, the event information data generated by the screen design apparatus.

14. The screen display system of claim 13, further comprising: a screen component providing apparatus provides the screen display apparatus with the screen component upon request from the screen display apparatus.

15. A computer readable storage medium having stored therein a computer program for causing a computer to function as the screen display program generating apparatus of claim 2, the computer including a memory for storing data and a processor for processing data.

16. A computer readable storage medium having stored therein a computer program for causing a computer to function as the screen display program generating apparatus of claim 3, the computer including a memory for storing data and a processor for processing data.

17. A computer readable storage medium having stored therein a computer program for causing a computer to function as the screen display program generating apparatus of claim 8, the computer including a memory for storing data and a processor for processing data.
